(19) United States
(12) Patent Application Publication
(10) Pub. No.: US 2009/0103947 A1
(43) Pub. Date: Apr. 23, 2009

(54) Exposure Head, An Image Forming Apparatus and An Image Forming Method

(75) Inventors: Nozomu INOUE, Matsumoto-shi (JP); Yujiro NOMURA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/252,239

(22) Filed: Oct. 15, 2008

(30) Foreign Application Priority Data
Oct. 18, 2007 (JP) 2007-271676
Aug. 27, 2008 (JP) 2008-218169

(51) Int. Cl. G03G 15/04

(52) U.S. Cl. 399/177

(57) ABSTRACT

An image forming apparatus, includes: a latent image carrier that moves in a moving direction; and an exposure head that includes a light emitting element which emits a light and an imaging optical system which images the light emitted from the light emitting element, and is adapted to form a spot on the latent image carrier, wherein a pitch in the moving direction of the latent image carrier between the spots formed by the different imaging optical systems is an integral multiple of a pixel pitch in the moving direction of the latent image carrier.

### CROSS REFERENCE TO RELATED APPLICATION

The disclosure of Japanese Patent Applications No. 2007-271676 filed on Oct. 18, 2007 and No. 2008-218169 filed on Aug. 27, 2008 including specification, drawings and claims is incorporated herein by reference in its entirety.

### BACKGROUND

1. Technical Field

The invention relates to an exposure head for imaging light beams emitted from a light emitting element by an imaging optical system, and an image forming apparatus using the exposure head and an image forming method.

2. Related Art

An exposure head for imaging light beams emitted from light emitting elements as spots is known as such an exposure head. For example, in an exposure head disclosed in JP-A-2004-66758, a number of light emitting elements corresponding to one line are arranged in a direction corresponding to a main scanning direction and light beams emitted from the respective light emitting elements are imaged as spots by gradient index lenses. Latent images are successively formed line by line on an image plane moving in a sub scanning direction, whereby a two-dimensional latent image corresponding to a desired image is formed.

### SUMMARY

Upon forming better spot latent images, it is desirable to form the spot latent images with sufficient light quantities by increasing the size of the respective light emitting elements. However, in the above construction in which the light emitting elements corresponding to one line are arranged, it is not easy to increase the size of the light emitting elements. This is because of a possibility of producing interference between adjacent light emitting elements in the case of making the light emitting elements larger. Even more, as in the case where a pitch between light emitting elements is made smaller for higher resolution, it is even more difficult to increase the size of the light emitting elements.

Accordingly, in order to easily realize better spot latent image formation, an exposure head having the following construction can be used. In this exposure head, light emitting elements are grouped into light emitting element groups. In addition, light emitting element groups are displaced from each other in a direction (width direction of the exposure head) corresponding to the sub scanning direction. By displacing the light emitting element groups in the width direction in this way, it becomes possible to easily increase the size of the light emitting elements and to realize good spot latent image formation.

This exposure head can form latent images on an image plane as follows. In other words, by switching the light emissions of the respective light emitting element groups at timings in conformity with a movement of the image plane in the sub scanning direction, spot latent images are formed on pixels provided on the image plane.

However, as described above, the plurality of light emitting element groups are displaced from each other in the width direction in this exposure head. Accordingly, there have been cases where the light emissions need to be switched at different timings for the respective light emitting element groups to properly form the spot latent images on the pixels of the image plane. As a result, there has been a problem of complicating an emission switching timing control.

An advantage of some aspects of the invention is to provide technology enabling the application of a common light emission switching timing control to light emitting element groups displaced from each other in a width direction and the realization of simplifying an emission switching timing control.

According to a first aspect of the invention, there is provided an image forming apparatus, comprising: a latent image carrier that moves in a moving direction; and an exposure head that includes a light emitting element which emits a light and an imaging optical system which images the light emitted from the light emitting element, and is adapted to form a spot on the latent image carrier, wherein a pitch in the moving direction of the latent image carrier between the spots formed by the different imaging optical systems is an integral multiple of a pixel pitch in the moving direction of the latent image carrier.

According to a second aspect of the invention, there is provided an exposure head, comprising: a light emitting element which emits a light; and an imaging optical system which images the light emitted from the light emitting element, wherein a spot is formed on a surface-to-be-exposed which moves in a moving direction, and a pitch between the imaging optical systems in the moving direction of the surface-to-be-exposed is an integral multiple of a value obtained by multiplying a pitch between the light emitting elements in a direction orthogonal to or substantially orthogonal to the moving direction of the surface-to-be-exposed by an absolute value of an optical magnification of the imaging optical system.

According to a third aspect of the invention, there is provided an image forming method, comprising: moving a latent image carrier in a moving direction; and forming a spot on the latent image carrier with a light imaged by an imaging optical system of an exposure head, wherein a pitch in the moving direction of the latent image carrier between spots formed by the different imaging optical systems is an integral multiple of a pixel pitch in the moving direction of the latent image carrier.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIGS. 1 and 2 are diagrams showing terminology used in this specification.

FIG. 3 is a diagram showing an embodiment of an image forming apparatus to which the invention is applicable.

FIG. 4 is a diagram showing the electrical construction of the image forming apparatus of FIG. 3.

FIG. 5 is a perspective view schematically showing a line head.

FIG. 6 is a sectional view along a width direction of the line head shown in FIG. 5.

FIG. 7 is a schematic partial perspective view of the lens array.

FIG. 8 is a sectional view of the lens array in the longitudinal direction LGD.

FIG. 9 is a diagram showing the construction of the under surface of the head substrate.

FIG. 10 is a diagram showing the arrangement of the light emitting elements in each light emitting element group.

FIG. 11 is a block diagram showing the construction of the main controller.

FIG. 12 is a block diagram showing the construction of the head controller.

FIG. 13 is a block diagram showing the construction of the head control block in this embodiment.

FIG. 14 is a group of charts showing signals transferred between the head controller and the main controller, in which horizontal axes represent time.

FIG. 15 is a perspective view showing the spot forming operation.

FIG. 16 is a diagram showing spot groups formed on the photosensitive drum surface at the emission switching timing Ta in this embodiment.

FIG. 17 is a diagram showing spot groups formed on the photosensitive drum surface at the emission switching timing Tb in this embodiment.

FIG. 18 is a diagram showing the in-group sub-scanning positions.

FIG. 19 is a diagram showing an exemplary spot latent image forming operation.

FIG. 20 is a block diagram showing the construction of a head control block according to a second embodiment.

FIG. 21 is a diagram showing spot groups formed on the photosensitive drum surface at an emission switching timing Tu in the second embodiment.

FIG. 22 is a diagram showing another exemplary arrangement of the driving circuits.

FIG. 23 is a diagram showing spot groups formed on the photosensitive drum surface at an emission switching timing Tu in a third embodiment.

FIG. 24 is a diagram showing spot groups formed on the photosensitive drum surface at an emission switching timing Tu in a fourth embodiment.

FIG. 25 is a plan view showing another arrangement mode of light emitting elements.

FIG. 26 is a diagram showing spot groups formed on the photosensitive drum surface at an emission switching timing Ta by the line head of FIG. 25.

FIG. 27 is a diagram showing spot groups formed on the photosensitive drum surface at an emission switching timing Tb by the line head of FIG. 25.

FIG. 28 is a plan view showing still another arrangement mode of light emitting elements and corresponds to a plan view of the under surface of the head substrate 293 seen from the top surface side.

### DESCRIPTION OF EXEMPLARY EMBODIMENTS

### A. Description of Terms

Terms used in this specification are described before the description of embodiments of the invention.

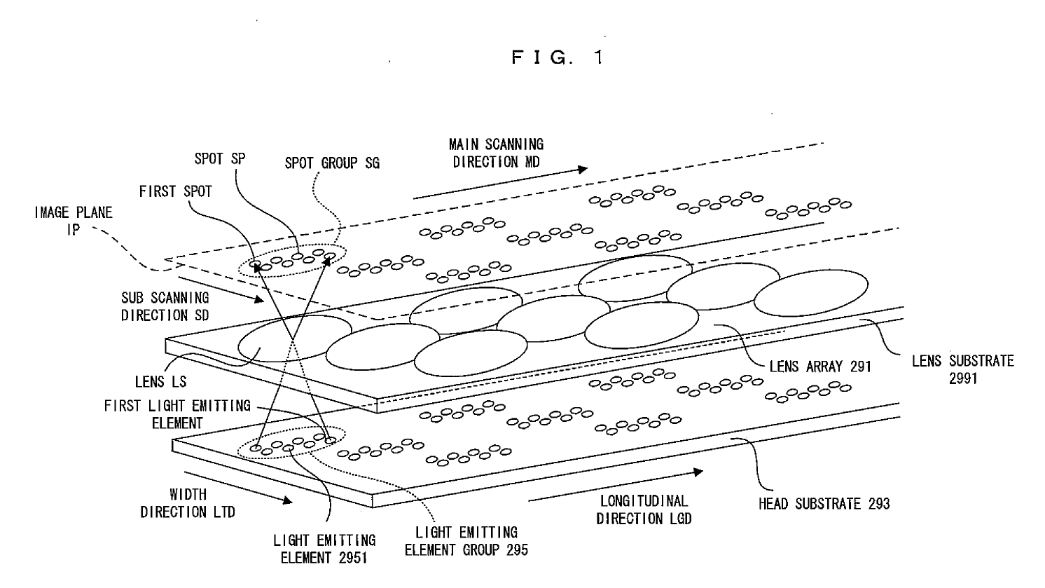

FIGS. 1 and 2 are diagrams showing terminology used in this specification. Here, terminology used in this specification is organized with reference to FIGS. 1 and 2. In this specification, a conveying direction of a surface (image plane IP) of a photosensitive drum 21 is defined to be a sub scanning direction SD and a direction orthogonal to or substantially orthogonal to the sub scanning direction SD is defined to be a main scanning direction MD. Further, a line head 29 is arranged relative to the surface (image plane IP) of the photosensitive drum 21 such that its longitudinal direction LGD corresponds to the main scanning direction MD and its width direction LTD corresponds to the sub scanning direction SD.

Collections of a plurality of (eight in FIGS. 1 and 2) light emitting elements 2951 arranged on a head substrate 293 in one-to-one correspondence with a plurality of lenses LS of a lens array 299 are defined to be light emitting element groups 295. In other words, in the head substrate 293, the plurality of light emitting element groups 295 including the plurality of light emitting elements 2951 are arranged in conformity with the plurality of lenses LS, respectively. Further, collections of a plurality of spots SP formed on the image plane IP by imaging light beams from the light emitting element groups 295 toward the image plane IP by the lenses LS corresponding to the light emitting element groups 295 are defined to be spot groups SG. In other words, a plurality of spot groups SG can be formed in one-to-one correspondence with the plurality of light emitting element groups 295. In each spot group SG; the most upstream spot in the main scanning direction MD and the sub scanning direction SD is particularly defined to be a first spot. The light emitting element 2951 corresponding to the first spot is particularly defined to be a first light emitting element.

A spot group row SGR and a spot group column SGC are defined as shown in the column “On Image Plane” of FIG. 2. Specifically, a plurality of spot groups SG arranged in the main scanning direction MD are defined as the spot group row SGR. A plurality of spot group rows SGR are arranged at specified spot group row pitches Psgr in the sub scanning direction SD. Further, a plurality of (three in FIG. 2) spot groups SG arranged at spot group row pitches Psgr in the sub scanning direction SD and at spot group pitches Psg in the main scanning direction MD are defined as the spot group column SGC. The spot group row pitch Psgr is a distance in the sub scanning direction SD between the geometric centers of gravity of two spot group rows SGR adjacent in the sub scanning direction SD, and the spot group pitch Psg is a distance in the main scanning direction MD between the geometric centers of gravity of two spot groups SG adjacent in the main scanning direction MD.

Lens rows LSR and lens columns LSC are defined as shown in the column of “Lens Array” of FIG. 2. Specifically, a plurality of lenses LS aligned in the longitudinal direction LGD is defined to be the lens row LSR. A plurality of lens rows LSR are arranged at specified lens row pitches Plsr in the width direction LTD. Further, a plurality of (three in FIG. 2) lenses LS arranged at the lens row pitches Plsr in the width direction LTD and at lens pitches Pls in the longitudinal direction LGD are defined to be the lens column LSC. It should be noted that the lens row pitch Plsr is a distance in the width direction LTD between the geometric centers of gravity of two lens rows LSR adjacent in the width direction LTD, and that the lens pitch Pls is a distance in the longitudinal direction LGD between the geometric centers of gravity of two lenses LS adjacent in the longitudinal direction LGD.

Light emitting element group rows 295R and light emitting element group columns 295C are defined as in the column “Head Substrate” of FIG. 2. Specifically, a plurality of light emitting element groups 295 aligned in the longitudinal direction LGD is defined to be the light emitting element group row 295R. A plurality of light emitting element group rows 295R are arranged at specified light emitting element group row pitches Pegr in the width direction LTD. Further, a plurality of (three in FIG. 2) light emitting element groups 295 arranged at the light emitting element group row pitches Pegr in the width direction LTD and at light emitting element group pitches Peg in the longitudinal direction LGD are defined to be the light emitting element group column 295C. It should be noted that the light emitting element group row pitch Pegr is a distance in the width direction LTD between the geometric centers of gravity of two light emitting element group rows 295R adjacent in the width direction LTD, and that the light emitting element group pitch Peg is a distance in the longitudinal direction LGD between the geometric centers of gravity of two light emitting element groups 295 adjacent in the longitudinal direction LGD.

Light emitting element rows 2951R and light emitting element columns 2951C are defined as in the column “Light emitting element Group” of FIG. 2. Specifically, in each light emitting element group 295, a plurality of light emitting elements 2951 aligned in the longitudinal direction LGD is defined to be the light emitting element row 2951R. A plurality of light emitting element rows 2951R are arranged at specified light emitting element row pitches Pelr in the width direction LTD. Further, a plurality of (two in FIG. 2) light emitting elements 2951 arranged at the light emitting element row pitches Pelr in the width direction LTD and at light emitting element pitches Pel in the longitudinal direction LGD are defined to be the light emitting element column 2951C. It should be noted that the light emitting element row pitch Pelr is a distance in the width direction LTD between the geometric centers of gravity of two light emitting element rows 2951R adjacent in the width direction LTD, and that the light emitting element pitch Pel is a distance in the longitudinal direction LGD between the geometric centers of gravity of two light emitting elements 2951 adjacent in the longitudinal direction LGD.

Spot rows SPR and spot columns SPC are defined as shown in the column “Spot Group” of FIG. 2. Specifically, in each spot group SG, a plurality of spots SG aligned in the longitudinal direction LGD is defined to be the spot row SPR. A plurality of spot rows SPR are arranged at specified spot row pitches Pspr in the width direction LTD. Further, a plurality of (two in FIG. 2) spots arranged at the spot row pitches Pspr in the width direction LTD and at spot pitches Psp in the longitudinal direction LGD are defined to be the spot column SPC. It should be noted that the spot row pitch Pspr is a distance in the sub scanning direction SD between the geometric centers of gravity of two spot rows SPR adjacent in the sub scanning direction SD, and that the spot pitch Psp is a distance in the main scanning direction MD between the geometric centers of gravity of two spots SP adjacent in the main scanning direction MD.

### B. First Embodiment

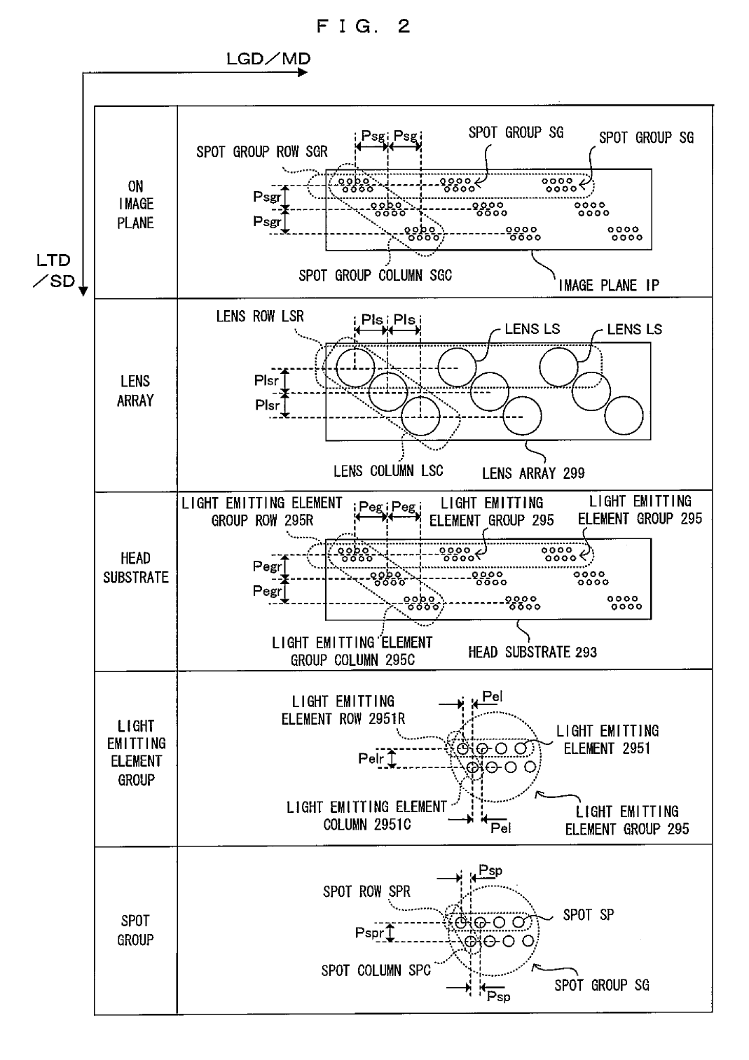

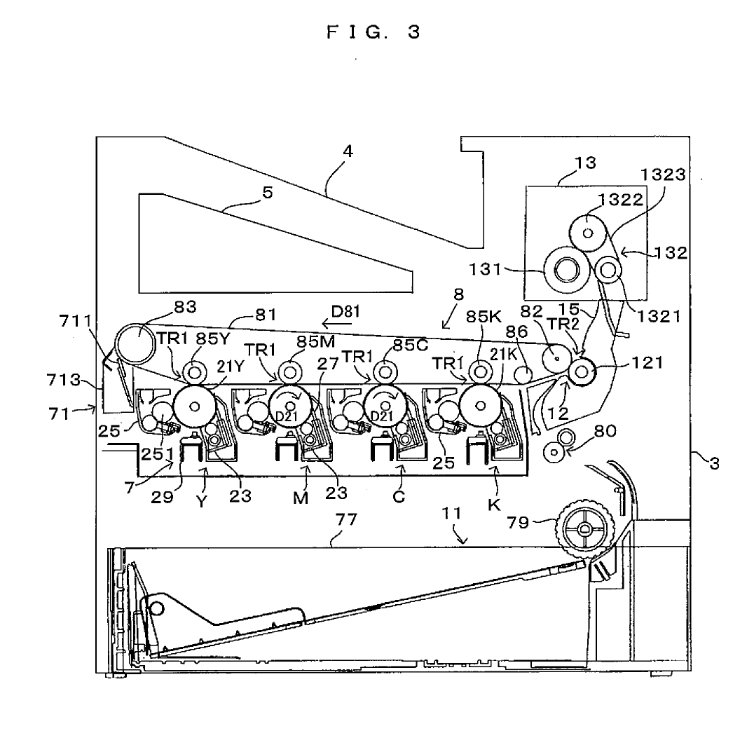

FIG. 3 is a diagram showing an embodiment of an image forming apparatus to which the invention is applicable. FIG. 4 is a diagram showing the electrical construction of the image forming apparatus of FIG. 3. This apparatus is an image forming apparatus that can selectively execute a color mode for forming a color image by superimposing four color toners of black (K), cyan (C), magenta (M) and yellow (Y) and a monochromatic mode for forming a monochromatic image using only black (K) toner. FIG. 3 is a diagram corresponding to the execution of the color mode. In this image forming apparatus, when an image formation command is given from an external apparatus such as a host computer to a main controller MC having a CPU and memories, the main controller MC feeds a control signal and the like to an engine controller EC and feeds video data VD corresponding to the image formation command to a head controller HC. This head controller HC controls line heads 29 of the respective colors based on the video data VD from the main controller MC, a vertical synchronization signal Vsync from the engine controller EC and parameter values from the engine controller EC. In this way, an engine part EG performs a specified image forming operation to form an image corresponding to the image formation command on a sheet such as a copy sheet, transfer sheet, form sheet or transparent sheet for OHP.

An electrical component box 5 having a power supply circuit board, the main controller MC, the engine controller EC and the head controller HC built therein is disposed in a housing main body 3 of the image forming apparatus. An image forming unit 7, a transfer belt unit 8 and a sheet feeding unit 11 are also arranged in the housing main body 3. A secondary transfer unit 12, a fixing unit 13 and a sheet guiding member 15 are arranged at the right side in the housing main body 3 in FIG. 3. It should be noted that the sheet feeding unit 11 is detachably mountable into the housing main body 3. The sheet feeding unit 11 and the transfer belt unit 8 are so constructed as to be detachable for repair or exchange respectively.

The image forming unit 7 includes four image forming stations Y (for yellow), M (for magenta), C (for cyan) and K (for black) which form a plurality of images having different colors. Each of the image forming stations Y, M, C and K includes a cylindrical photosensitive drum 21 having a surface of a specified length in a main scanning direction MD. Each of the image forming stations Y, M, C and K forms a toner image of the corresponding color on the surface of the photosensitive drum 21. The photosensitive drum is arranged so that the axial direction thereof is substantially parallel to the main scanning direction MD. Each photosensitive drum 21 is connected to its own driving motor and is driven to rotate at a specified speed in a direction of arrow D21 in FIG. 3, whereby the surface of the photosensitive drum 21 is transported in the sub scanning direction SD which is orthogonal to or substantially orthogonal to the main scanning direction MD. Further, a charger 23, the line head 29, a developer 25 and a photosensitive drum cleaner 27 are arranged in a rotating direction around each photosensitive drum 21. A charging operation, a latent image forming operation and a toner developing operation are performed by these functional sections. Accordingly, a color image is formed by superimposing toner images formed by all the image forming stations Y, M, C and K on a transfer belt 81 of the transfer belt unit 8 at the time of executing the color mode, and a monochromatic image is formed using only a toner image formed by the image forming station K at the time of executing the monochromatic mode. Meanwhile, since the respective image forming stations of the image forming unit 7 are identically constructed, reference characters are given to only some of the image forming stations while being not given to the other image forming stations in order to facilitate the diagrammatic representation in FIG. 3.

The charger 23 includes a charging roller having the surface thereof made of an elastic rubber. This charging roller is constructed to be rotated by being held in contact with the surface of the photosensitive drum 21 at a charging position. As the photosensitive drum 21 rotates, the charging roller is rotated at the same circumferential speed in a direction driven by the photosensitive drum 21. This charging roller is connected to a charging bias generator (not shown) and charges the surface of the photosensitive drum 21 at the charging position where the charger 23 and the photosensitive drum 21 are in contact upon receiving the supply of a charging bias from the charging bias generator.

The line head 29 is arranged relative to the photosensitive drum 21 so that the longitudinal direction thereof corresponds to the main scanning direction MD and the width direction thereof corresponds to the sub scanning direction SD. Hence, the longitudinal direction of the line head 29 is substantially parallel to the main scanning direction MD. The line head 29 includes a plurality of light emitting elements arrayed in the longitudinal direction and is positioned separated from the photosensitive drum 21. Light beams are emitted from these light emitting elements toward the surface of the photosensitive drum 21 charged by the charger 23, thereby forming an electrostatic latent image on this surface.

The developer 25 includes a developing roller 251 carrying toner on the surface thereof By a development bias applied to the developing roller 251 from a development bias generator (not shown) electrically connected to the developing roller 251, charged toner is transferred from the developing roller 251 to the photosensitive drum 21 to develop the electrostatic latent image formed by the line head 29 at a development position where the developing roller 251 and the photosensitive drum 21 are in contact.

The toner image developed at the development position in this way is primarily transferred to the transfer belt 81 at a primary transfer position TR1 to be described later where the transfer belt 81 and each photosensitive drum 21 are in contact after being transported in the rotating direction D21 of the photosensitive drum 21.

Further, the photosensitive drum cleaner 27 is disposed in contact with the surface of the photosensitive drum 21 downstream of the primary transfer position TR1 and upstream of the charger 23 with respect to the rotating direction D21 of the photosensitive drum 21. This photosensitive drum cleaner 27 removes the toner remaining on the surface of the photosensitive drum 21 to clean after the primary transfer by being held in contact with the surface of the photosensitive drum.

The transfer belt unit 8 includes a driving roller 82, a driven roller (blade facing roller) 83 arranged to the left of the driving roller 82 in FIGS. 3, and the transfer belt 81 mounted on these rollers. The transfer belt unit 8 also includes four primary transfer rollers 85Y, 85M, 85C and 85K arranged to face in a one-to-one relationship with the photosensitive drums 21 of the respective image forming stations Y, M, C and K inside the transfer belt 81 when the photosensitive cartridges are mounted. These primary transfer rollers 85Y, 85M, 85C and 85K are respectively electrically connected to a primary transfer bias generator (not shown). As described in detail later, at the time of executing the color mode, all the primary transfer rollers 85Y, 85M, 85C and 85K are positioned on the sides of the image forming stations Y, M, C and K as shown in FIG. 3, whereby the transfer belt 81 is pressed into contact with the photosensitive drums 21 of the image forming stations Y, M, C and K to form the primary transfer positions TR1 between the respective photosensitive drums 21 and the transfer belt 81. By applying primary transfer biases from the primary transfer bias generator to the primary transfer rollers 85Y, 85M, 85C and 85K at suitable timings, the toner images formed on the surfaces of the respective photosensitive drums 21 are transferred to the surface of the transfer belt 81 at the corresponding primary transfer positions TR1 to form a color image.

On the other hand, out of the four primary transfer rollers 85Y, 85M, 85C and 85K, the color primary transfer rollers 85Y, 85M, 85C are separated from the facing image forming stations Y, M and C and only the monochromatic primary transfer roller 85K is brought into contact with the image forming station K at the time of executing the monochromatic mode, whereby only the monochromatic image forming station K is brought into contact with the transfer belt 81. As a result, the primary transfer position TR1 is formed only between the monochromatic primary transfer roller 85K and the image forming station K. By applying a primary transfer bias at a suitable timing from the primary transfer bias generator to the monochromatic primary transfer roller 85K, the toner image formed on the surface of the photosensitive drum 21 is transferred to the surface of the transfer belt 81 at the primary transfer position TR1 to form a monochromatic image.

The transfer belt unit 8 further includes a downstream guide roller 86 disposed downstream of the monochromatic primary transfer roller 85K and upstream of the driving roller 82. This downstream guide roller 86 is so disposed as to come into contact with the transfer belt 81 on an internal common tangent to the primary transfer roller 85K and the photosensitive drum 21 at the primary transfer position TR1 formed by the contact of the monochromatic primary transfer roller 85K with the photosensitive drum 21 of the image forming station K.

The driving roller 82 drives to rotate the transfer belt 81 in the direction of the arrow D81 and doubles as a backup roller for a secondary transfer roller 121. A rubber layer having a thickness of about 3 mm and a volume resistivity of 1000 kΩ·cm or lower is formed on the circumferential surface of the driving roller 82 and is grounded via a metal shaft, thereby serving as an electrical conductive path for a secondary transfer bias to be supplied from an unillustrated secondary transfer bias generator via the secondary transfer roller 121. By providing the driving roller 82 with the rubber layer having high friction and shock absorption, an impact caused upon the entrance of a sheet into a contact part (secondary transfer position TR2) of the driving roller 82 and the secondary transfer roller 121 is unlikely to be transmitted to the transfer belt 81 and image deterioration can be prevented.

The sheet feeding unit 11 includes a sheet feeding section which has a sheet cassette 77 capable of holding a stack of sheets, and a pickup roller 79 which feeds the sheets one by one from the sheet cassette 77. The sheet fed from the sheet feeding section by the pickup roller 79 is fed to the secondary transfer position TR2 along the sheet guiding member 15 after having a sheet feed timing adjusted by a pair of registration rollers 80.

The secondary transfer roller 121 is provided freely to abut on and move away from the transfer belt 81, and is driven to abut on and move away from the transfer belt 81 by a secondary transfer roller driving mechanism (not shown). The fixing unit 13 includes a heating roller 131 which is freely rotatable and has a heating element such as a halogen heater built therein, and a pressing section 132 which presses this heating roller 131. The sheet having an image secondarily transferred to the front side thereof is guided by the sheet guiding member 15 to a nip portion formed between the heating roller 131 and a pressure belt 1323 of the pressing section 132, and the image is thermally fixed at a specified temperature in this nip portion. The pressing section 132 includes two rollers 1321 and 1322 and the pressure belt 1323 mounted on these rollers. Out of the surface of the pressure belt 1323, a part stretched by the two rollers 1321 and 1322 is pressed against the circumferential surface of the heating roller 131, thereby forming a sufficiently wide nip portion between the heating roller 131 and the pressure belt 1323. The sheet having been subjected to the image fixing operation in this way is transported to the discharge tray 4 provided on the upper surface of the housing main body 3.

Further, a cleaner 71 is disposed facing the blade facing roller 83 in this apparatus. The cleaner 71 includes a cleaner blade 711 and a waste toner box 713. The cleaner blade 711 removes foreign matters such as toner remaining on the transfer belt after the secondary transfer and paper powder by holding the leading end thereof in contact with the blade facing roller 83 via the transfer belt 81. Foreign matters thus removed are collected into the waste toner box 713. Further, the cleaner blade 711 and the waste toner box 713 are constructed integral to the blade facing roller 83. Accordingly, when the blade facing roller 83 moves, the cleaner blade 711 and the waste toner box 713 move together with the blade facing roller 83.

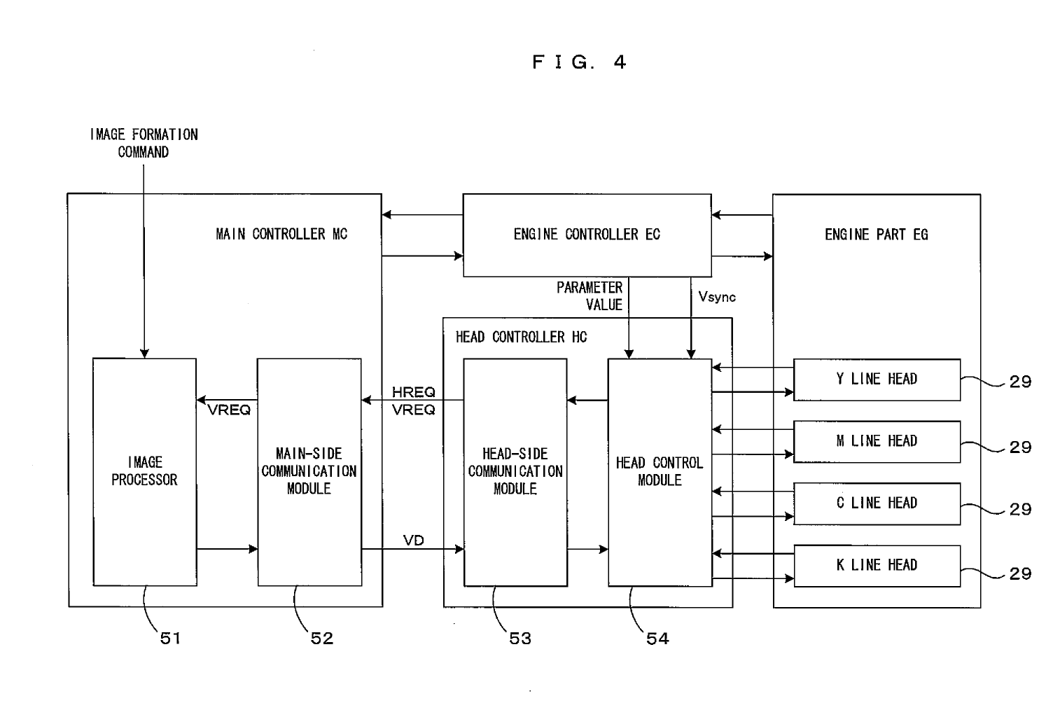

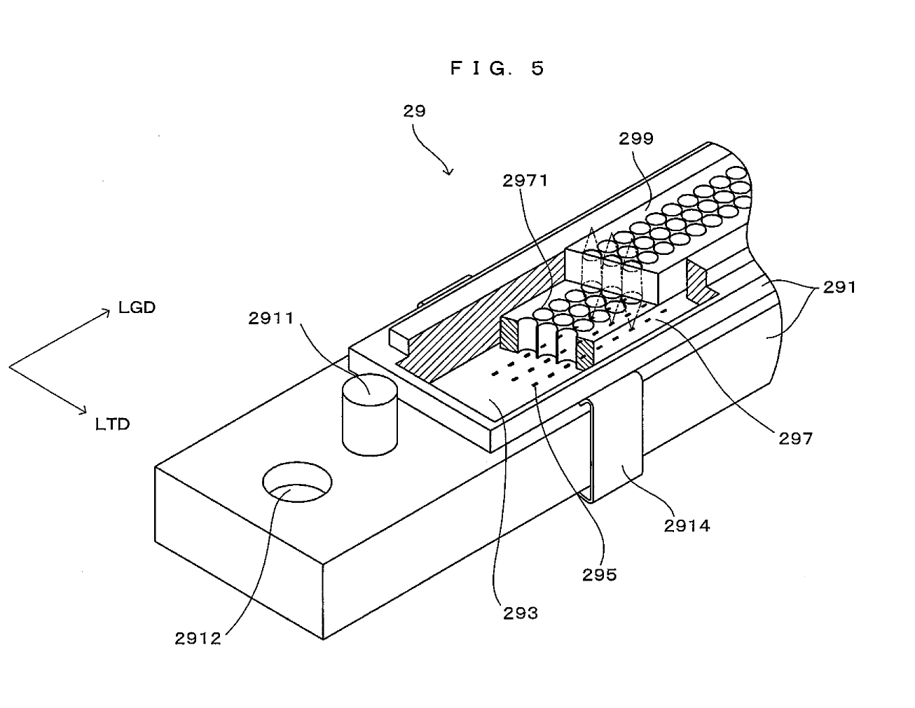

FIG. 5 is a perspective view schematically showing a line head, and FIG. 6 is a sectional view along a width direction of the line head shown in FIG. 5. As described above, the line head 29 is arranged to face the photosensitive drum 21 such that the longitudinal direction LGD corresponds to the main scanning direction MD and the width direction LTD corresponds to the sub scanning direction SD. The longitudinal direction LGD and the width direction LTD are substantially normal to each other. The line head 29 is positioned relative to the photosensitive drum 21 by fitting such positioning pins 2911 into positioning holes (not shown) perforated in a photosensitive drum cover (not shown) covering the photosensitive drum 21 and positioned relative to the photosensitive drum 21. Further, the line head 29 is positioned and fixed relative to the photosensitive drum 21 by screwing fixing screws into screw holes (not shown) of the photosensitive drum cover via the screw insertion holes 2912 to be fixed.

The case 291 carries a lens array 299 at a position facing the surface of the photosensitive drum 21, and includes a light shielding member 297 and a head substrate 293 inside, the light shielding member 297 being closer to the lens array 299 than the head substrate 293. The head substrate 293 is made of a transmissive material (glass for instance). Further, a plurality of bottom emission-type EL (electroluminescence) devices are provided on an under surface of the head substrate 293 (surface opposite to the lens array 299 out of two surfaces of the head substrate 293) as the plurality of light emitting elements 2951. The plurality of light emitting elements 2951 are arranged as groups for each light emitting element group 295 as described later. The light beams emitted from the respective light emitting element groups 295 propagate toward the light shielding member 297 after passing through the head substrate 293 from the under surface thereof to a top surface thereof.

The light shielding member 297 is perforated with a plurality of light guide holes 2971 in a one-to-one correspondence with the plurality of light emitting element groups 295. The light guide holes 2971 are substantially cylindrical holes penetrating the light shielding member 297 and having central axes in parallel with normals to the head substrate 293. Accordingly, out of light beams emitted from the light emitting element groups 295, those propagating toward other than the light guide holes 2971 corresponding to the light emitting element groups 295 are shielded by the light shielding member 297. In this way, all the lights emitted from one light emitting element group 295 propagate toward the lens array 299 via the same light guide hole 2971 and the mutual interference of the light beams emitted from different light emitting element groups 295 can be prevented by the light shielding member 297. The light beams having passed through the light guide holes 2971 perforated in the light shielding member 297 are imaged as spots on the surface of the photosensitive drum 21 by the lens array 299.

As shown in FIG. 6, an underside lid 2913 is pressed against the case 291 via the head substrate 293 by retainers 2914. Specifically, the retainers 2914 have elastic forces to press the underside lid 2913 toward the case 291, and seal the inside of the case 291 light-tight (that is, so that light does not leak from the inside of the case 291 and so that light does not intrude into the case 291 from the outside) by pressing the underside lid by means of the elastic force. It should be noted that a plurality of the retainers 2914 are provided at a plurality of positions in the longitudinal direction of the case 291. The light emitting element groups 295 are covered with a sealing member 294.

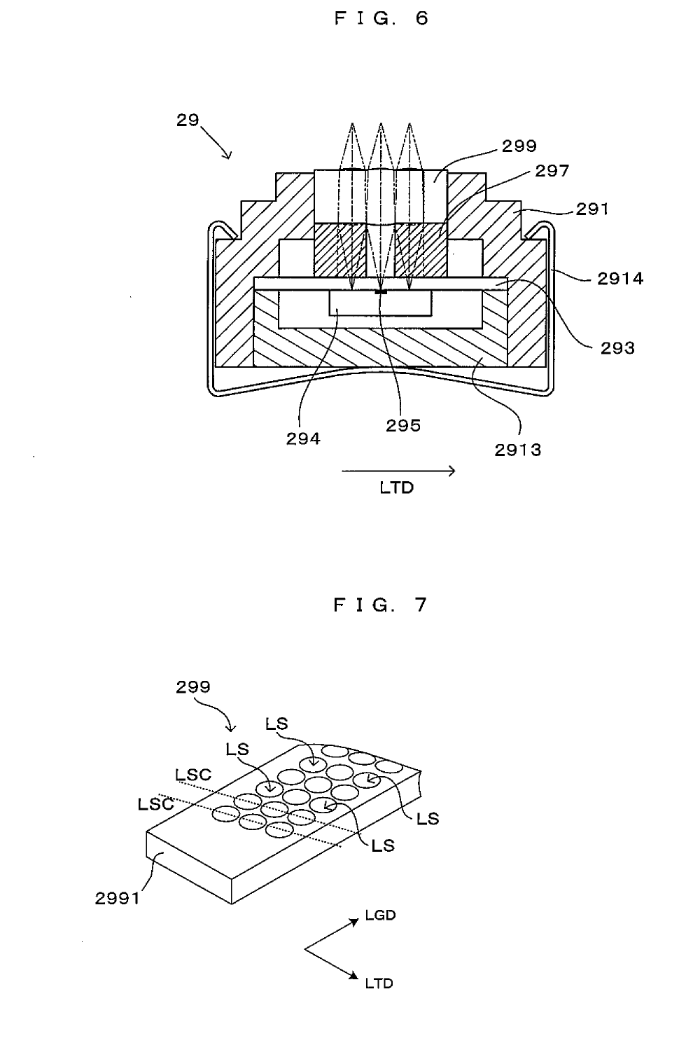

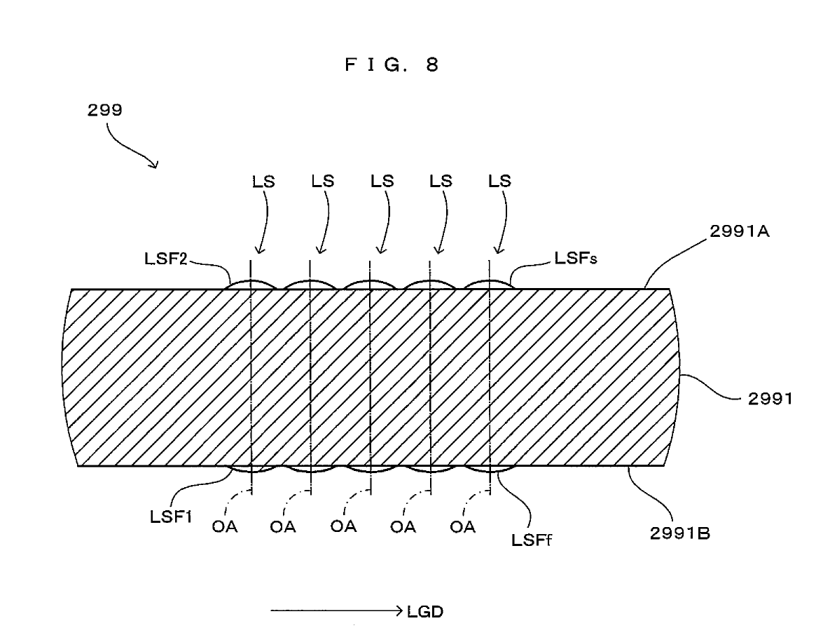

FIG. 7 is a schematic partial perspective view of the lens array, and FIG. 8 is a sectional view of the lens array in the longitudinal direction LGD. The lens array 299 includes a lens substrate 2991. First surfaces LSFf of the lenses LS are formed on an under surface 2991B of the lens substrate 2991, and second surfaces LSFs of the lenses LS are formed on a top surface 2991A of the lens substrate 2991. The first and second surfaces LSFf, LSFs facing each other and the lens substrate 2991 held between these two surfaces function as one lens LS. The first and second surfaces LSFf, LSFs of the lenses LS can be made of resin for instance.

The lens array 299 is arranged such that optical axes OA of a plurality of lenses LS are substantially parallel to each other. The lens array 299 is also arranged such that the optical axes OA of the lenses LS are substantially orthogonal to an under surface (surface where the light emitting elements 2951 are arranged) of the head substrate 293. The lenses LS are provided in a one-to-one correspondence with the light emitting element groups 295, and a plurality of lenses LS are two-dimensionally arranged in conformity with the arrangement of the light emitting element groups 295 to be described later. In other words, a plurality of lens columns LSC each including three lenses LS arranged at mutually different positions in the width direction LTD are arranged in the longitudinal direction LGD.

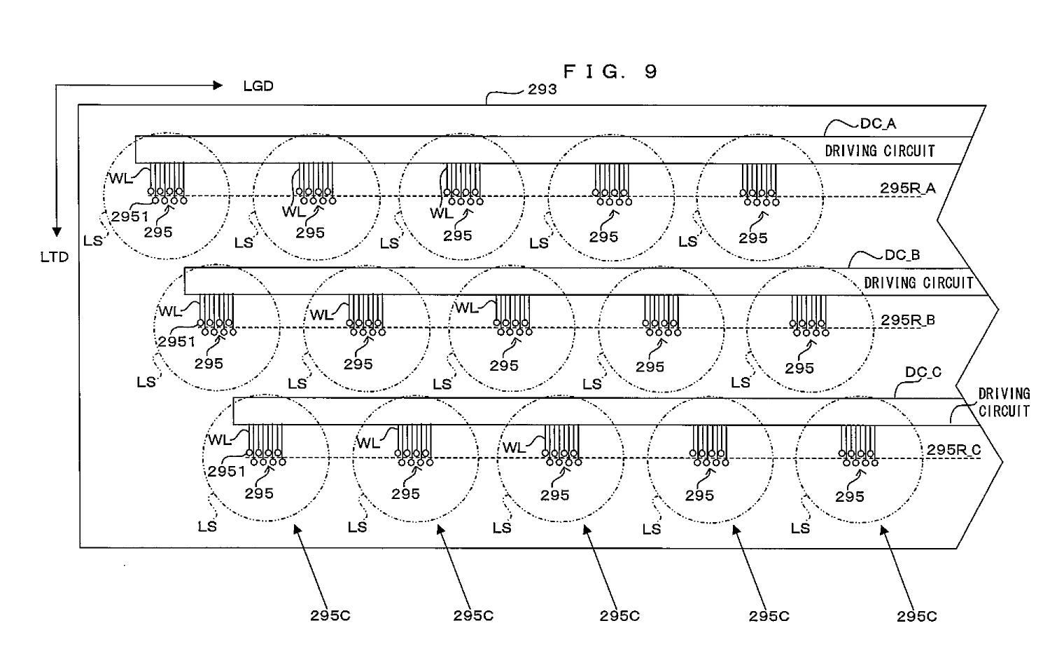

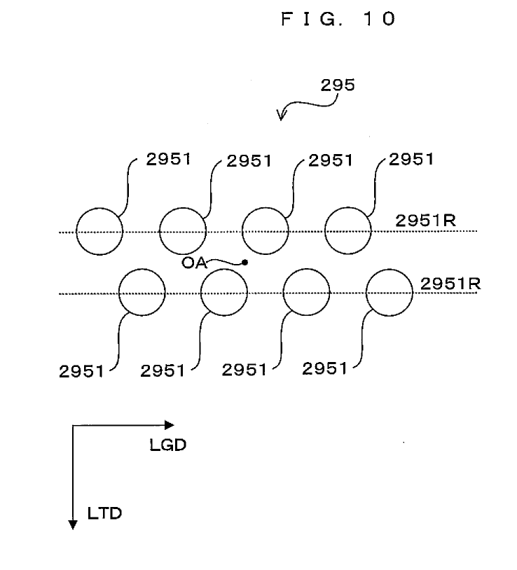

FIG. 9 is a diagram showing the construction of the under surface of the head substrate and corresponds to a case where the under surface of the head substrate is seen from the top surface. FIG. 10 is a diagram showing the arrangement of the light emitting elements in each light emitting element group. In FIG. 9, the lenses LS are shown by chain double-dashed line to show that the light emitting element groups 295 are provided in a one-to-one correspondence with the lenses LS, but not to show that the lenses LS are arranged on the under surface of the head substrate. As shown in FIG. 9, the plurality of lens columns LSC each including three lenses LS arranged at mutually different positions in the width direction LTD are arranged in the longitudinal direction LGD. In other words, three light emitting element group rows 295R each including a plurality of light emitting element groups 295 arranged in the longitudinal direction LGD are arranged in the width direction LTD. At this time, the respective light emitting element group rows 295R are displaced from each other in the longitudinal direction LGD lest the respective light emitting element groups 295 should overlap each other in the longitudinal direction LGD. Here, the three light emitting element group rows are identified by 295R_A, 295R_B and 295R_C in this order from the upstream side in the width direction LTD.

In each light emitting element group 295, two light emitting element rows 2951R each including four light emitting elements 2951 aligned in the longitudinal direction LGD are arranged in the width direction LTD (FIG. 10). At this time, the respective light emitting element rows 2951R are displaced from each other in the longitudinal direction LGD lest the respective light emitting elements 2951 should overlap each other in the longitudinal direction LGD. As a result, eight light emitting elements 2951 are arranged in an offset manner. As shown in FIG. 10, each light emitting element group 295 is arranged symmetrically with respect to the optical axis OA of the corresponding lens LS. In other words, eight light emitting elements 2951 constituting the light emitting element group 295 are arranged symmetrically with respect to the optical axis OA. Accordingly, light beams from the light emitting elements 2951 relatively distant from the optical axis OA can be also imaged with less aberrations.

Driving circuits DC_A (for the light emitting element group row 295R_A), DC_B (for the light emitting element group row 295R_B) and DC_C (for the light emitting element group row 295R_C) are provided corresponding to the respective light emitting element group rows 295R_A, 295R_B and 295R_C. These driving circuits DC_A, etc. are constructed, for example, by TFTs (thin film transistors) (FIG. 9). The respective driving circuits DC_A, etc. are arranged at one sides of the corresponding light emitting element groups 295R_A, etc. in the width direction LTD, and are connected to the light emitting elements 2951 of the light emitting element group 295R_A, etc. via wiring WL. When the driving circuits DC_A, etc. feed drive signals to the respective light emitting elements 2951, the respective light emitting elements 2951 emit light beams of the same wavelength. The light emitting surfaces of the light emitting elements 2951 are so-called perfectly diffusing surface illuminants and the light beams emitted from the light emitting surfaces comply with Lambert's cosine law.

The driving operations of the driving circuits DC are controlled based on video data VD. In other words, the main controller MC generates video data VD of one page upon receiving a vertical request signal VREQ from the head controller HC (FIG. 4). Every time the main controller MC receives a horizontal request signal HREQ from the head controller HC, the video data VD of one line is transmitted to the head controller HC. The head controller HC controls the driving circuits DC based on the received video data VD. Next, a specific construction for realizing these control operations is described.

In this embodiment, there are four sets of the respective signals, that is, the request signals VREQ, HREQ transmitted from the head controller HC to the main controller MC and the video data VD transmitted from the main controller MC to the head controller HC corresponding to the respective colors Y, M, C and K. Colors are distinguished below by attaching a hyphen and symbol representing the color to each signal if necessary. For example, the vertical request signal, horizontal request signal and video data for yellow are expressed by VREQ-Y, HREQ-Y and VD-Y.

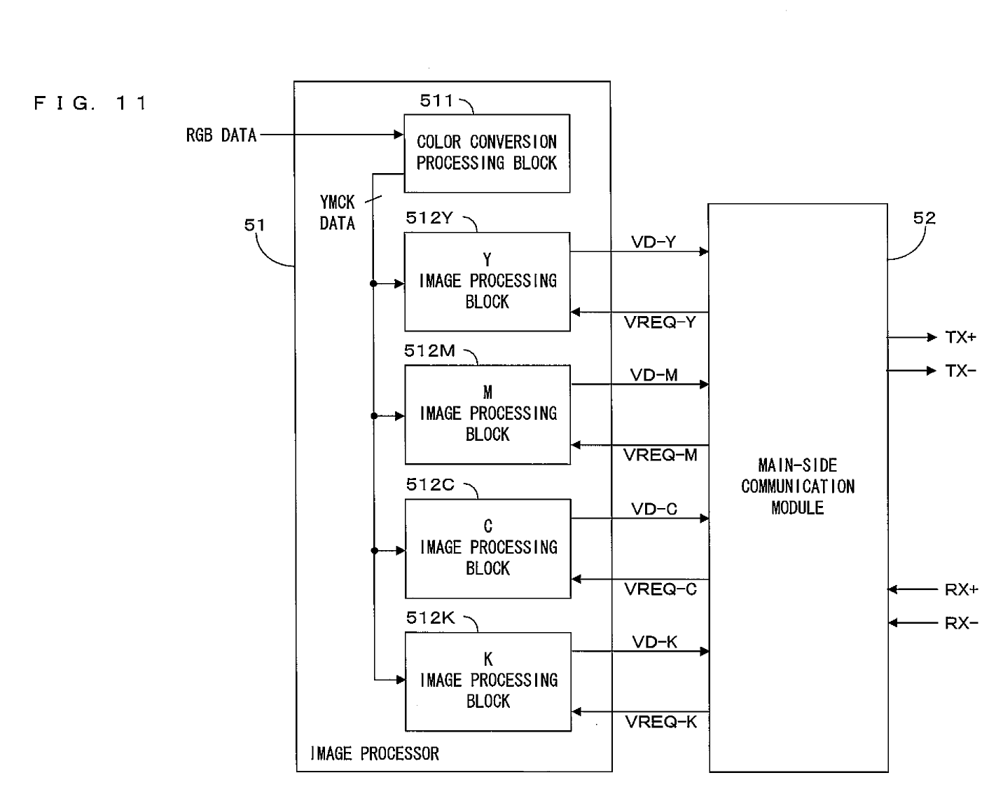

FIG. 11 is a block diagram showing the construction of the main controller. The main controller MC includes an image processor 51 for applying necessary signal processing to image data included in an image formation command given from an external apparatus, and a main-side communication module 52. The image processor 51 includes a color conversion processing block 511 for expanding RGB image data into YMCK image data corresponding to the respective toner colors. The image processor 51 also includes image processing blocks 512Y (for yellow), 512M (for magenta), 512C (for cyan) and 512K (for black) corresponding to the respective toner colors, and the following signal processings are applied to the image data. In other words, in the image processing blocks 512Y, etc., the image data is bitmap expanded in accordance with the resolution of the line head 29, and screen processing and gamma correction are performed to the data after the bitmap expansion to generate the video data VD-Y, etc. In this way, the image data is converted into information with pixels as minimum units. Here, the pixels are the minimum units constituting the image to be formed by the line head 29. These series of signal processings are performed for an image of one page every time the vertical request signal VREQ-Y is inputted, and the generated video data VD-Y, etc. are successively outputted line by line to the main-side communication module 52.

In the main-side communication module 52, the video data VD-Y, VD-M, VD-C and VD-K of four colors outputted from the image processor 51 are time-division multiplexed, and the video data VD after multiplexing are serially transmitted to the head controller HC via differential output terminals TX+, TX−. On the other hand, the time-division multiplexed vertical request signals VREQ-Y, VREQ-M, VREQ-C, VREQ-K and horizontal request signals HREQ-Y, HREQ-M, IREQ-C and HREQ-K are inputted from the head controller HC via differential input terminals RX+, RX−. These request signals VREQ, HREQ are parallelly expanded and the vertical request signals VREQ (VREQ-Y, etc.) of the respective colors are inputted to the image processing blocks 512 (512Y, etc.) of the corresponding colors.

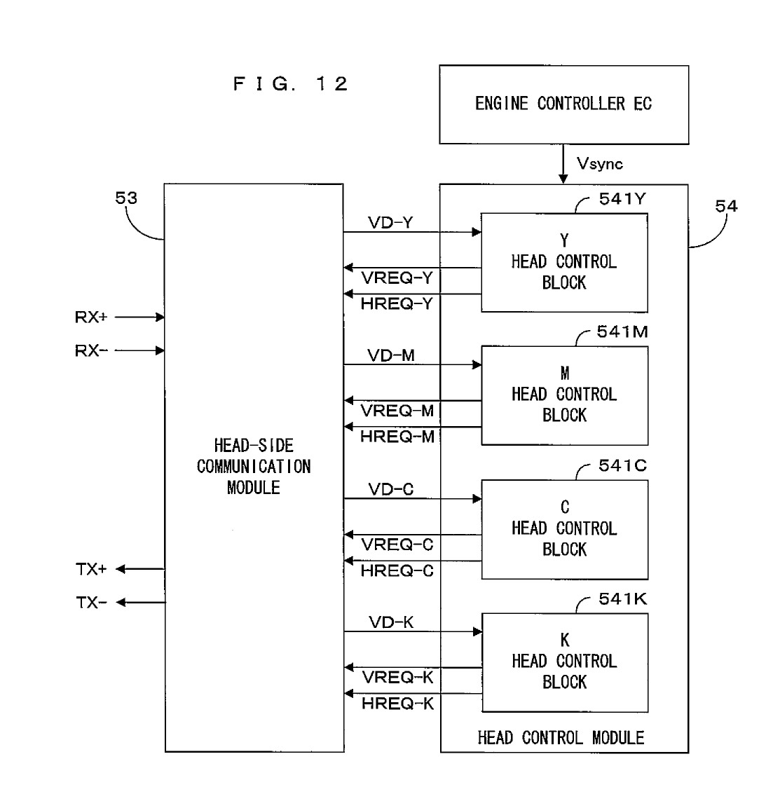

FIG. 12 is a block diagram showing the construction of the head controller. The head controller HC includes a head-side communication module 53 and a head control module 54. In the head-side communication module 53, the respective request signals of four colors outputted from the head control module 54, that is, vertical request signals VREQ-Y, VREQ-M, VREQ-C, VREQ-K and horizontal request signals HREQ-Y, HREQ-M, HREQ-C and HREQ-K are time-division multiplexed. The time-division multiplexed request signals are serially transmitted to the main controller MC via the differential output terminals TX+, TX−. On the other hand, the time-division multiplexed video data VD-Y, VD-M, VD-C and VD-K are inputted from the main controller MC via the differential input terminals RX+, RX−. These video data VD-Y, etc. are parallelly expanded and inputted to head control blocks 541Y, etc. of the corresponding colors.

In the head control module 54, the four head control blocks 541Y (for yellow), 541M (for magenta), 541C (for cyan) and 541K (for black) are provided corresponding to the respective colors. The head control blocks 541Y, etc. output the respective request signals VREQ-Y, HREQ-Y, etc. to request the video data VD-Y, etc., whereas they control the exposure operations of the line heads 29 of the corresponding colors based on the received video data VD-Y, etc.

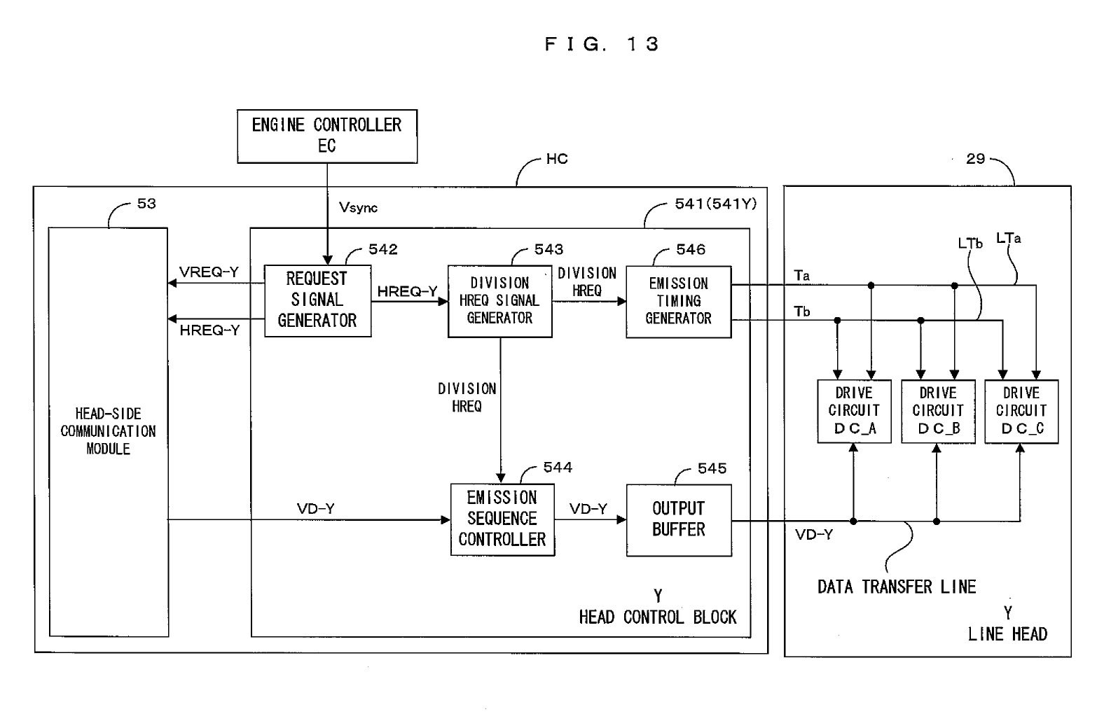

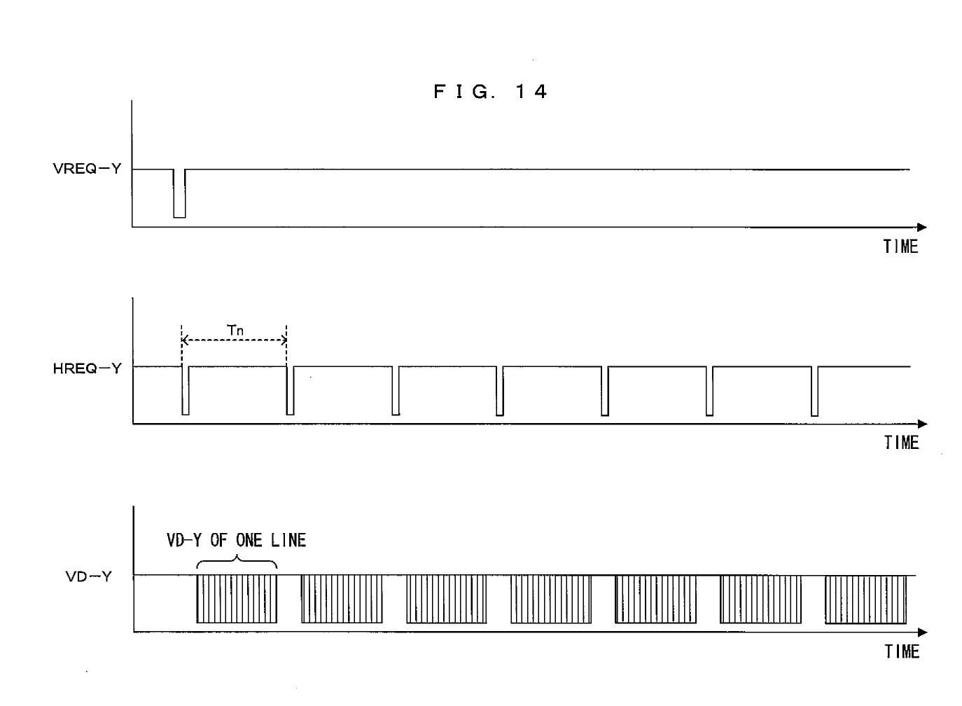

FIG. 13 is a block diagram showing the construction of the head control block in this embodiment, and FIG. 14 is a group of charts showing signals transferred between the head controller and the main controller, in which horizontal axes represent time. The constructions and operations of the head controller and the main controller are described below with reference to FIGS. 13 and 14. The head control block 541Y for yellow is described here. The other respective blocks 541M, 541C and 541K also have the same construction. The Y head control block 541Y includes a request signal generator 542 for generating the request signals VREQ-Y, HREQ-Y in accordance with a synchronization signal Vsync fed from the engine controller EC. The request signal generator 542 starts counting by means of an internal timer upon receiving the synchronization signal Vsync and outputs the vertical request signal VREQ-Y indicating the head of a page upon the elapse of a specified standby time. Following the output of the vertical request signal VREQ-Y, the request signal generator 542 repeatedly outputs a number of horizontal request signals HREQ-Y corresponding to the number of lines constituting an image of one page in a specified cycle Tn (FIG. 14). These request signals VREQ-Y, HREQ-Y are transmitted to the head-side communication module 53 and time-division multiplexed together with the request signals of the other colors to be transmitted to the main controller MC. The main controller MC transmits the video data VD-Y (FIG. 14) of one line to the head controller HC every time receiving the horizontal request signal HREQ-Y.

The horizontal request signal HREQ-Y is further inputted to a division HREQ signal generator 543, which generates a division HREQ signal by multiplying the inputted request signal HREQ-Y, for example, to 16-fold. This division HREQ signal is inputted to an emission sequence controller 544, which rearranges the video data VD-Y in accordance with the division HREQ signal. Such data rearrangement is for rearranging the video data VD-Y received line by line from the head of the page in an order to be transmitted to the driving circuits DC-A, etc.

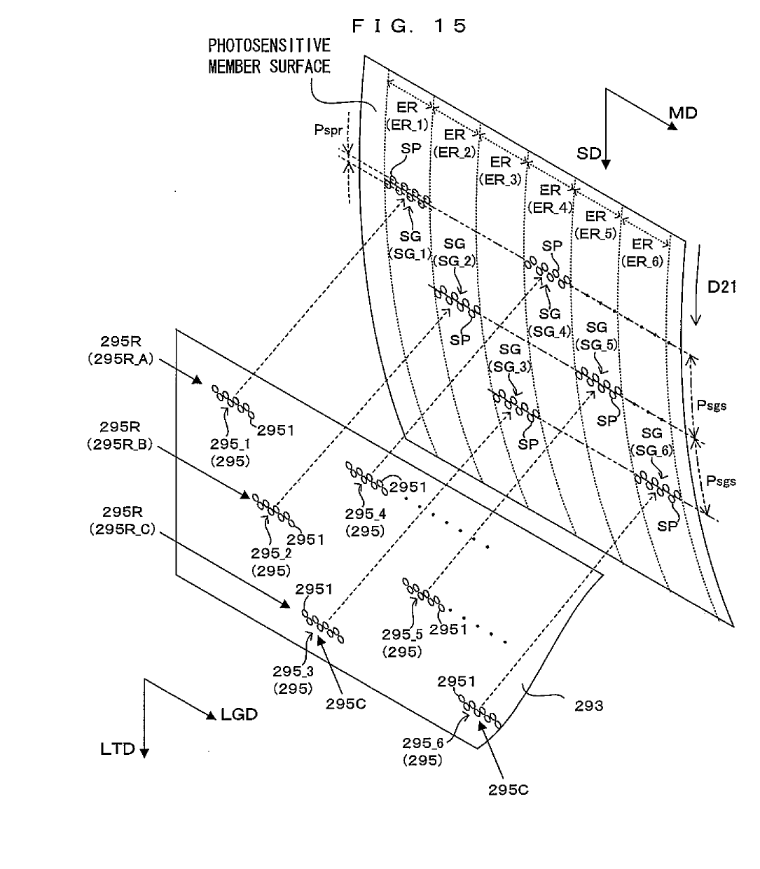

Specifically, as described later, the respective light emitting element group rows 295R form the spot groups SG at positions mutually displaced by a sub-scanning spot group pitch Psgs (FIGS. 15 to 17, etc.). Accordingly, in order to form and arrange spot latent images of one line in the main scanning direction MD, the video data VD-Y need to be transmitted to the driving circuit DC_A, etc., considering differences in the formation positions of the spot groups SG. Specifically, when a value obtained by dividing the sub-scanning spot group pitch Psgs by a sub-scanning pixel pitch Rsd is a “delay line number”, the video data VD-Y are rearranged such that the video data VD-Y displaced by the delay line number in the sub scanning direction SD are transmitted to the respective light emitting element group rows 295R_A, etc. at the same timing. For example, at the timing of transmitting the video data VD-Y of the first line to the light emitting element group row 295R_A, the video data VD-Y of the 161st line (=1 line+delay line number) is transmitted to the light emitting element group row 295R_B and the video data VD-Y of the 321st line (=1 line+2×(delay line number) is transmitted to the light emitting element group row 295R_C. The spot latent images are latent images formed on the photosensitive drum surface by the spots SP.

An output buffer 545 supplies the thus rearranged video data VD-Y to the respective driving circuits DC_A, DC_B and DC_C via data transfer lines. This output buffer 545 is constructed, for example, by a shift register, and the data transfer lines leading from the output buffer 545 to the respective driving circuits DC_A, etc. are shared among the driving circuits. The driving circuits DC_A, etc. drive the light emitting elements 2951 for light emission based on the video data VD-Y supplied from the output buffer 545. At this time, the driving of the driving circuits DC_A, etc. is performed in synchronization with emission switching timings Ta, Tb supplied from an emission timing generator 546 to be described next.

The division HREQ signal is also inputted to the emission timing generator 546, which generates the emission switching timings Ta, Tb in accordance with this division HREQ signal. The emission timing generator 546 is connected to the respective driving circuits DC_A, etc. via two emission timing control lines LTa, LTb, which are shared among the driving circuits. The emission timing generator 546 supplies the emission switching timing Ta to the respective driving circuits DC_A, etc. via the emission timing control line LTa and the emission switching timing Tb to the respective driving circuits DC_A, etc. via the emission timing control line LTb. The driving circuits DC_A, etc. drive the light emitting elements 2951 of the corresponding light emitting element group rows 295R_A, etc. at the respective emission switching timings Ta, Tb based on the video data VD-Y supplied beforehand. By controlling the light emissions of the light emitting elements 2951 using the respective emission switching timings Ta, Tb in this way, it becomes possible to form the respective spots SP on the pixels PX of the photosensitive drum surface. Such a spot forming operation is described below.

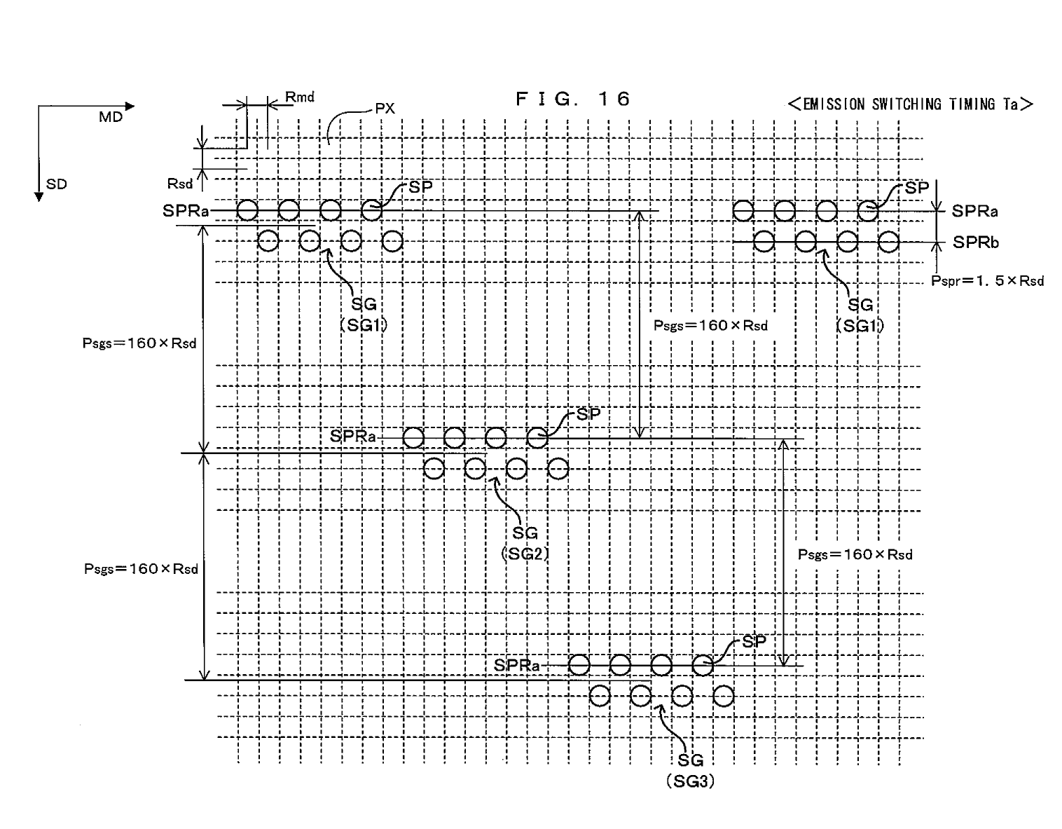

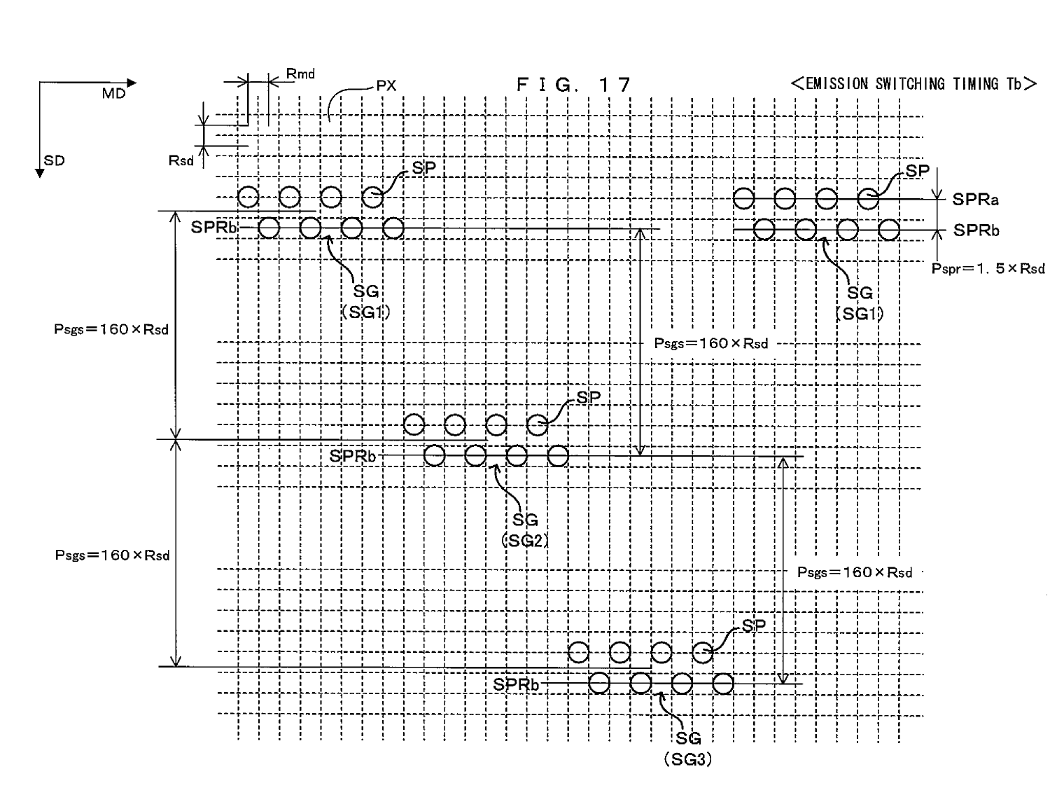

FIG. 15 is a perspective view showing the spot forming operation, FIG. 16 is a diagram showing spot groups formed on the photosensitive drum surface at the emission switching timing Ta in this embodiment, and FIG. 17 is a diagram showing spot groups formed on the photosensitive drum surface at the emission switching timing Tb in this embodiment. The lens array 299 is not shown in FIG. 15. Here, the spot formation at the emission switching timings Ta, Tb is described after a relationship between the spot groups SG and the pixels PX is described.

As shown in FIG. 15, the respective light emitting element groups 295 can form the spot groups SG in exposure regions ER mutually different in the main scanning direction MD. Here, the spot group SG is a set of a plurality of spots SP formed by the simultaneous light emissions of all the light emitting elements 2951 of the light emitting element group 295. In this embodiment, three light emitting element groups 295 capable of forming the spot groups SG in the exposure regions ER consecutive in the main scanning direction MD are displaced from each other in the width direction LTD. In other words, three light emitting element groups 295_1, 295_2 and 295_3 capable of forming spot groups SG_1, SG_2 and SG_3, for example, in exposure regions ER_1, ER_2 and ER_3 consecutive in the main scanning direction MD are displaced from each other in the width direction LTD. These three light emitting element groups 295 constitute the light emitting element group column 295C, and a plurality of light emitting element group columns 295C are arranged in the longitudinal direction LGD. As a result, three light emitting element group rows 295R_A, 295R_B and 295R_C are arranged in the width direction LTD and the respective light emitting element group rows 295R_A, etc. form the spot groups SG at positions mutually different in the sub scanning direction SD as already described in the description of FIG. 9.

As shown by broken line in FIGS. 16 and 17, a plurality of pixels PX are virtually provided on the surface of the photosensitive drum 21. A plurality of pixel lines each made up of the pixels PX aligned in the main scanning direction MD are arranged in the sub scanning direction SD. A pitch between pixels adjacent in the main scanning direction MD is a main-scanning pixel pitch Rmd, and a pitch between adjacent pixels in the sub scanning direction SD is a sub-scanning pixel pitch Rsd. In FIGS. 16 and 17, both main-scanning resolution and sub-scanning resolution are 600 dpi (dots per inch) and the main-scanning pixel pitch Rmd and the sub-scanning pixel pitch Rsd are equal. Here, resolution is the density of pixels and indicates the number of pixels per inch.

In this embodiment, the pixels PX satisfy the following relationship. In other words, the cycle Tn of the horizontal request signal HREQ, a circumferential speed v of the photosensitive drum 21 and the pixel pitch Rsd satisfies the following formula:

Rsd=v×Tn.

The pixel pitch on the photosensitive drum surface can be obtained, for example, from a pixel pitch of an image formed on a sheet. However, there are cases where a moving speed of the photosensitive drum surface and a conveying speed of the sheet slightly differ in the sub scanning direction SD. In such cases, the sub-scanning pixel pitch differs between the photosensitive drum surface and the sheet. Accordingly, in the case of obtaining the sub-scanning pixel pitch on the photosensitive drum surface from an image formed on a sheet, the sub-scanning pixel pitch obtained from the image on the sheet may be multiplied by a speed ratio of the moving speed of the photosensitive drum surface to the conveying speed of the sheet. A value or the like written in the specification of the image forming apparatus such as a printer can be used as this speed ratio.

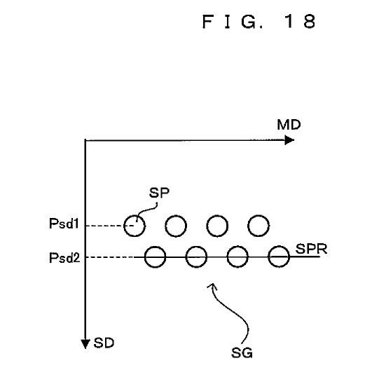

As shown in FIGS. 15 to 17, two spot rows SPRa, SPRb are arranged at the spot row pitch Pspr in the sub scanning direction SD in each spot group SG. The spot rows are identified by SPRa, SPRb in FIGS. 16 and 17 and the spot rows identified by the same reference numerals have the same positions (in-group sub-scanning positions) in the sub scanning direction SD in the spot groups SG. Here, the “in-group sub-scanning position” is the position of an object (spot or spot row) in the sub scanning direction SD with respect to MD-SD coordinate axes provided for each spot group SG. For example, in FIG. 18, the in-group sub-scanning position of the spot SP is a position Psd1, and the in-group sub-scanning position of the spot row SPR is a position Psd2. FIG. 18 is a diagram showing the in-group sub-scanning positions.

In this embodiment, this spot row pitch Pspr is set to be a non-integral multiple (1.5-fold) of the sub-scanning pixel pitch Rsd (FIGS. 16, 17). The spot groups SG formed by the different light emitting element group rows 295R are at positions different in the sub scanning direction SD, and these spot groups SG are arranged at the sub-scanning spot group pitches Psgs in the sub scanning direction SD. This sub-scanning spot group pitch Psgs is set to be an integral multiple (160-fold) of the sub-scanning pixel pitch Rsd. In this embodiment, the line head 29 is constructed such that the pitch Pegr between the light emitting element groups in the width direction LTD and the pitch Plsr between the lenses LS in the width direction LTD are equal and an integral multiple of the sub-scanning pixel pitch (160-fold). In other words, by constructing the line head 29 in this way, the sub-scanning spot group pitch Psgs can be easily set to an integral multiple of the sub-scanning pixel pitch Rsd.

As described above, in the line head of this embodiment, the sub-scanning spot group pitch Psgs is set to be an integral multiple of the sub-scanning pixel pitch Rsd. Accordingly, the pitch between the spot rows SPR located at the same in-group sub-scanning positions is an integral multiple of the sub-scanning pixel pitch Rsd. For example, a pitch between the spot rows SPRa of the spot groups SG1 and the spot rows SPRa of the spot groups SG2 located at the same in-group sub-scanning positions is an integral multiple of the sub-scanning pixel pitch Rsd (FIG. 16). Therefore, the respective spot rows located at the same in-group sub-scanning positions can be formed on the respective pixels PX at the same timings.

Accordingly, in this embodiment, the emission switching timings are the same for the spot rows located at the same in-group sub-scanning positions independently of the spot groups SG. In other words, the emission switching timing Ta is set for the respective light emitting element rows corresponding to the spot rows SPRa and the emission switching timing Tb is set for the respective light emitting element rows corresponding to the spot rows SPRb. The light emissions of the respective light emitting elements 2951 for forming the spots SP of the spot rows SPRa are switched at the timing Ta at which the respective spots SP of the spot rows SPRa reach positions corresponding to the pixels PX (FIG. 16). Here, the switch of light emissions means the switch from OFF to ON and the switch from ON to OFF. On the other hand, the light emissions of the respective light emitting elements 2951 for forming the spots SP of the spot rows SPRb are switched at the timing Tb at which the respective spots SP of the spot rows SPRb reach positions corresponding to the pixels PX (FIG. 17). In this embodiment, the light emissions of the light emitting elements 2951 are switched at such emission switching timings Ta, Tb, whereby the spots SP are formed on the respective pixels PX and spot latent images can be formed in the respective pixels PX.

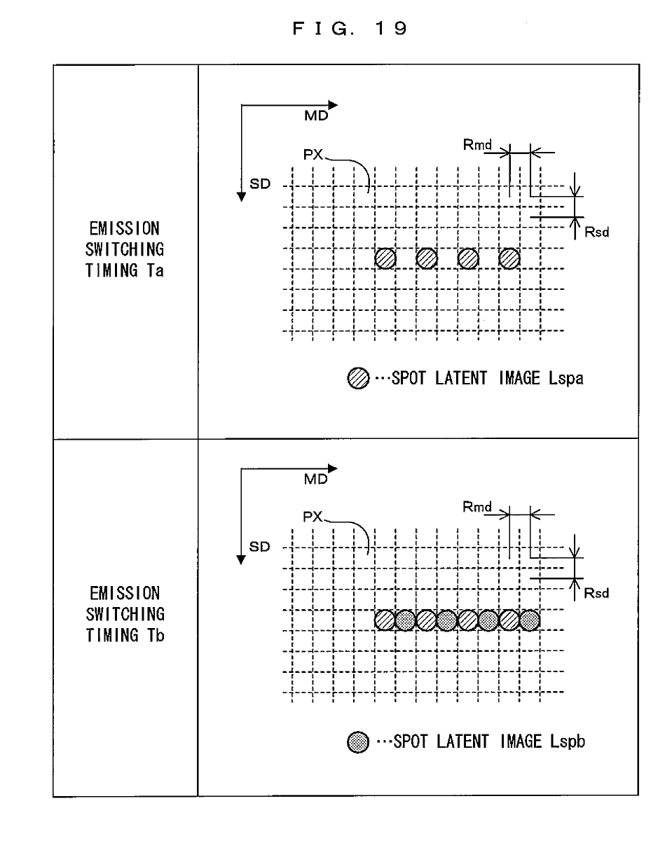

FIG. 19 is a diagram showing an exemplary spot latent image forming operation. As shown in the column “Emission Switching Timing Ta”, when the light emitting elements 2951 are driven at the emission switching timing Ta to form the respective spots SP of the spot rows SPRa, spot latent images Lspa are formed on the respective pixels PX. Subsequently, at the emission switching timing Tb, that is, when the surface of the photosensitive drum 21 moves a distance corresponding to the 1.5-fold of the sub-scanning pixel pitch Rsd, the light emitting elements 2951 are driven to form the respective spots SP of the spot rows SPRb. In this way, the spot latent images Lspa, Lspb are formed on the respective pixels PX by driving the light emitting elements 2951 at the respective emission switching timings Ta, Tb in conformity with a movement of the photosensitive drum surface.

As described above, in this embodiment, the sub-scanning spot group pitch Psgs is an integral multiple of the sub-scanning pixel pitch Rsd. Hence, the pitch in the sub scanning direction SD between the spot rows SPR located at the same in-group sub-scanning positions is an integral multiple of the sub-scanning pixel pitch Rsd. Accordingly, the spot rows SPR located at the same in-group sub-scanning positions can be formed on the respective pixels PX at the same timing. For example, all the spot rows SPRa of the respective spot groups SG can be formed on the pixels PX at the emission switching timing Ta. Thus, the emission switching timings Ta, Tb set for the spot rows SPRa, SPRb can be shared among the respective light emitting element groups 295, and the emission switching timing control can be simplified. Further, by using the common emission switching timings Ta, Tb, the emission timing control lines LTa, LTb can be shared among the respective light emitting element groups 295 and the construction of the line head 29 can be simplified (FIGS. 9 and 13).

In other words, the pitch Psgs in the sub scanning direction SD between the spots SP formed by the lenses LS arranged at positions different in the sub scanning direction SD is set to be an integral multiple of the pixel pitch Rsd in the sub scanning direction SD. For example, the pitch in the sub scanning direction SD between the spots SP of the spot rows SPRa of the spot groups SG1 and the spots SP of the spot rows SPRa of the spot groups SG2 is 160×Rsd. In this way, the emission switching timing control of the light emitting elements 2951 is simplified.

In this embodiment, the control in conformity with the construction of the line head 29 such as the rearrangement of the video data VD is executed by the head controller HC. Accordingly, it is sufficient for the main controller MC to output the video data VD of one line without considering the control in conformity with the line head 29 every time receiving the horizontal request signal HREQ. Therefore, the simplification of the control operation by the main controller MC is realized.

In this embodiment, the head controller HC is constructed to cyclically output the horizontal request signal HREQ, whereby the controls of the respective parts of the apparatus are further simplified.

Further, in this embodiment, it is made possible to arrange the driving circuit DC_A near the light emitting elements 2951 by separating the head controller HC and the driving circuits DC_A, etc. As a result, the influence of noise and the like produced on the way from the driving circuit DC_A to the light emitting elements 2951 on the other construction can be suppressed. As a result, the occurrence of the malfunction and the like of the image forming apparatus can be suppressed and images can be stably formed.

In this embodiment, the head controller HC calculates the timings for driving the light emitting elements 2951 in accordance with the horizontal request signals HREQ, whereby the control operation of the head controller HC can be simplified.

In this embodiment, by constructing the driving circuits DC_A, etc. by TFTs, the driving circuits DC_A, etc. with a good switching characteristic are realized.

In image formation using the photosensitive drum 21 as a latent image carrier as in this embodiment, the light emissions of the light emitting elements 2951 need to be controlled in conformity with the rotation of the photosensitive drum 21. Thus, the above construction designed to simplify the emission switching timing control of the light emitting elements 2951 is particularly suitable for image formation using the photosensitive drum 21.

In this embodiment, the line head 29 may include a light shielding member 297 which is provided with light guide holes 2971 between the light emitting elements 2951 and the lenses LS. By such a construction, crosstalk between different lenses LS can be suppressed and high-quality images can be formed.

In this embodiment, organic EL devices are used as the light emitting elements 2951, which is preferable. This is because the organic EL devices have high positional accuracy and can form high-quality images since being manufactured in a semiconductor process.

Further, bottom emission-type organic EL devices are used, which is preferable. This is because production cost can be suppressed and the relatively inexpensive formation of high-quality images can be realized.

As described above, in this embodiment, the main scanning direction MD corresponds to a “first direction” of the invention, the sub scanning direction SD to a “second direction” of the invention, the lens LS to an “imaging optical system” of the invention, the photosensitive drum 21 to a “latent image carrier” of the invention, the surface of the photosensitive drum 21 to an “image plane” of the invention, the head substrate 293 to a “substrate” of the invention, and the lens array 299 to an “array” of the invention Further, the line head 29 corresponds to an “exposure head” of the invention, the sub scanning direction SD to a “moving direction of the latent image carrier” of the invention, and the surface of the photosensitive drum 21 to a “surface-to-be-exposed” of the invention. Further, the horizontal request signal HREQ corresponds to a “line synchronizing request signal” of the invention.

### C. Miscellaneous

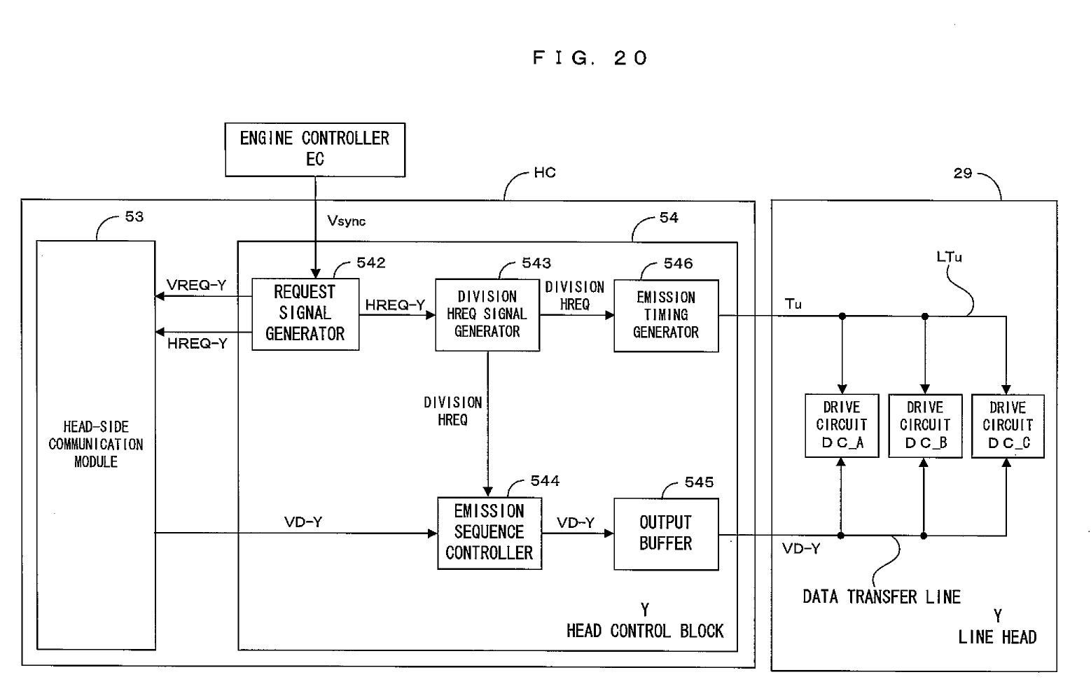

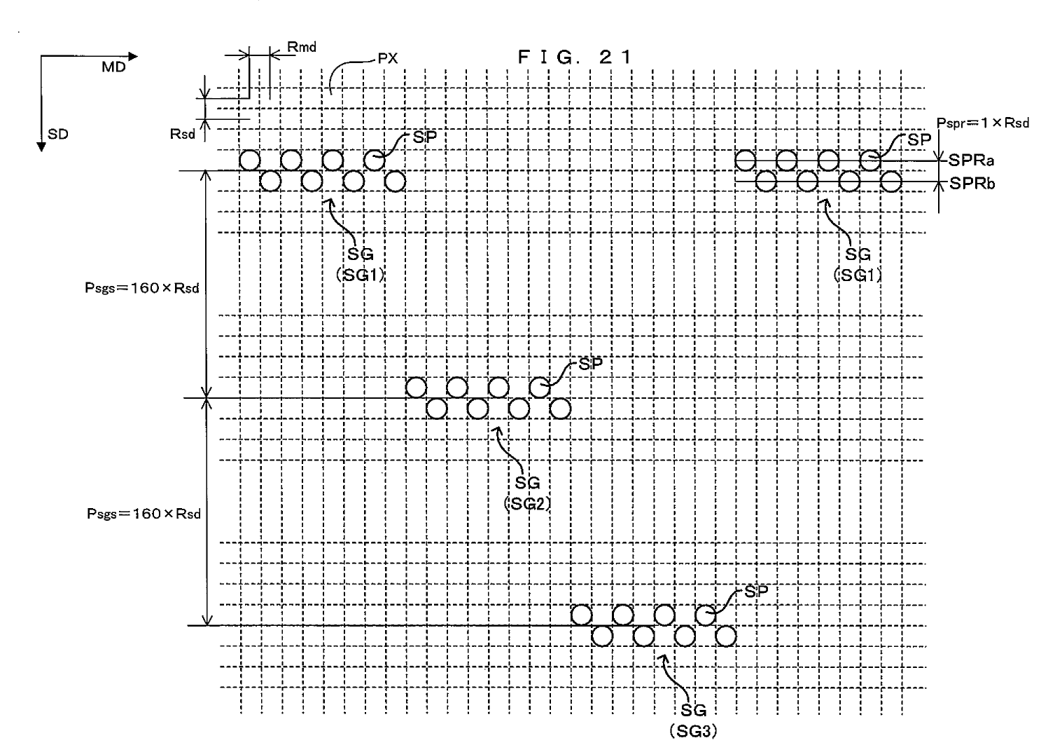

The invention is not limited to the above embodiment and various changes other than the above can be made without departing from the gist thereof For example, FIG. 20 is a block diagram showing the construction of a head control block according to a second embodiment, and FIG. 21 is a diagram showing spot groups formed on the photosensitive drum surface at an emission switching timing Tu in the second embodiment. In this embodiment as well, the sub-scanning spot group pitch Psgs is set to be an integral multiple (160-fold) of the sub-scanning pixel pitch Rsd. Further, in this embodiment, the pitch between the spots SP formed at positions different in the sub scanning direction SD in each spot group SG is set to be an integral multiple (1-fold) of the sub-scanning pixel pitch Rsd (FIG. 21). In other words, the pitch Pspr in the sub scanning direction SD between the spot rows SPRa, SPRb arranged in the sub scanning direction SD is set to be an integral multiple (1-fold) of the sub-scanning pixel pitch Rsd. By such a construction, the second embodiment shown in FIGS. 20 and 21 fulfills functions and effects as described below.

Specifically, in the second embodiment, all the spots SP are simultaneously formed on the pixels PX at the emission switching timing Tu. Accordingly, the spots SP can be properly formed on the respective pixels PX only by a control of driving all the light emitting elements 2951 at the same emission switching timing Tu, whereby the emission switching timing control is further simplified. Since all the light emitting elements 2951 can be controlled at the same emission switching timing Tu, it is possible to commonly use one emission timing control line LTu among all the light emitting element group rows 295R_A, 295R_B and 295R_C and the construction of the line head 29 is further simplified (FIG. 20).

In other words, in the second embodiment, the emission switching timing control of the light emitting elements 2951 is further simplified by setting the pitch (=Pspr) in the sub scanning direction SD between the spots SP formed at positions different in the sub scanning direction SD by one lens LS to be an integral multiple of the pitch Rsd between the pixels PX in the sub scanning direction SD.

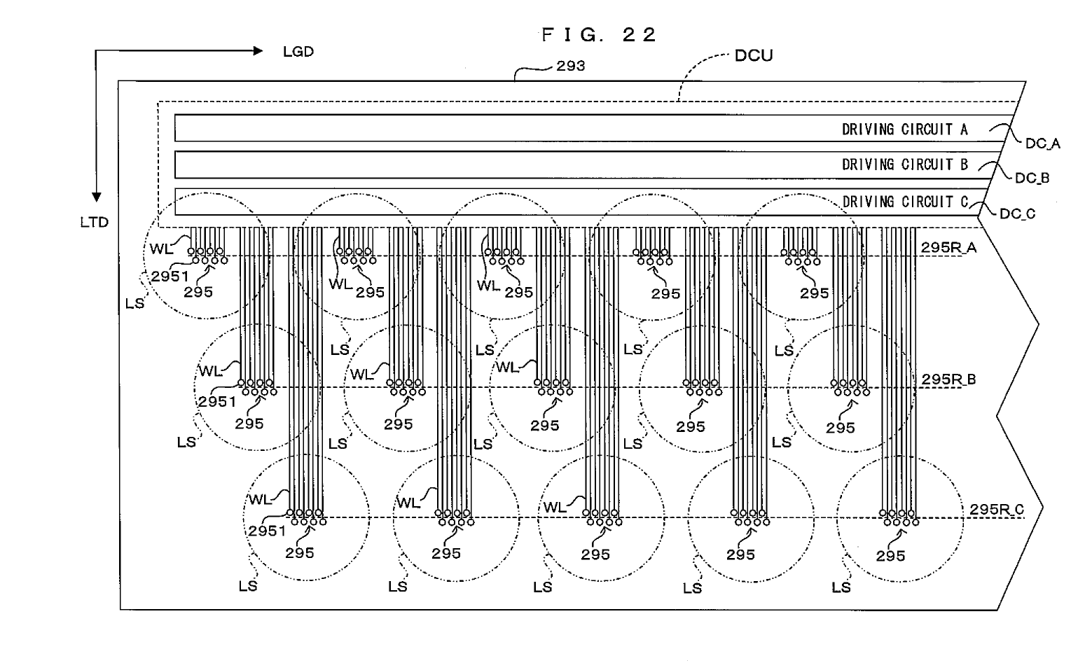

In the above embodiments, the respective driving circuits DC_A, etc. are arranged at one sides of the corresponding light emitting element group rows 295R_A, etc. in the width direction LTD as shown in FIG. 9. However, all the driving circuits DC_A to DC_C may, for example, be collectively arranged at one end of the head substrate 293 in the width direction LTD as shown in FIG. 22. Here, FIG. 22 is a diagram showing another exemplary arrangement of the driving circuits.

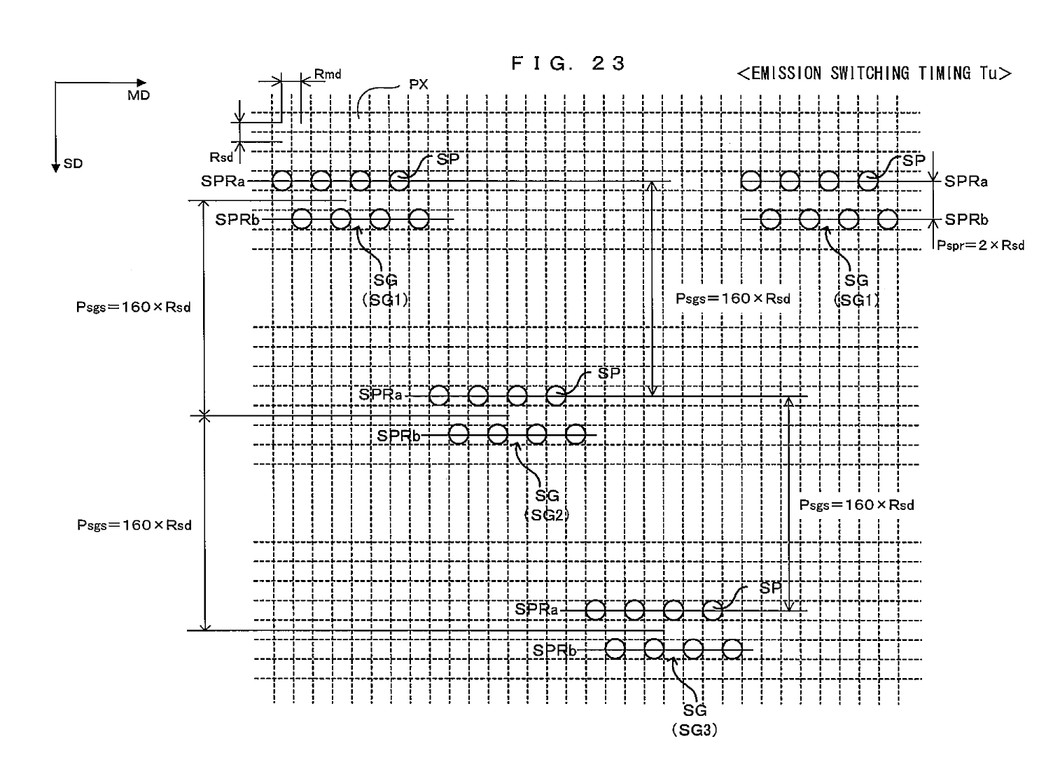

FIG. 23 is a diagram showing spot groups formed on the photosensitive drum surface at an emission switching timing Tu in a third embodiment. In this embodiment as well, the sub-scanning spot group pitch Psgs is set to be an integral multiple (160-fold) of the sub-scanning pixel pitch Rsd. Further, in this embodiment, the pitch between the spots SP formed at positions different in the sub scanning direction SD in each spot group SG is set to be an integral multiple (2-fold) of the sub-scanning pixel pitch Rsd. Accordingly, all the spots SP are simultaneously formed on the pixels PX at the emission switching timing Tu. Thus, the spots SP can be properly formed on the respective pixels PX only by controlling all the light emitting elements 2951 at the same emission switching timing Tu, whereby the emission switching timing control is further simplified.

In other words, in the third embodiment as well like the second embodiment, the emission switching timing control of the light emitting elements 2951 is further simplified by setting the pitch (=Pspr) in the sub scanning direction SD between the spots SP formed at positions different in the sub scanning direction SD by one lens LS to be an integral multiple of the pitch Rsd between the pixels PX in the sub scanning direction SD.

Further, in the above embodiments, each spot row SPR is made up of four spots SP, but the number of the spots SP constituting the spot row SPR is not limited to this.

Further, in the above embodiments, the spot group SG is made up of two spot rows SPR, but the number of the spot rows SPR constituting the spot group SG is not limited to this and may be one, three or more.

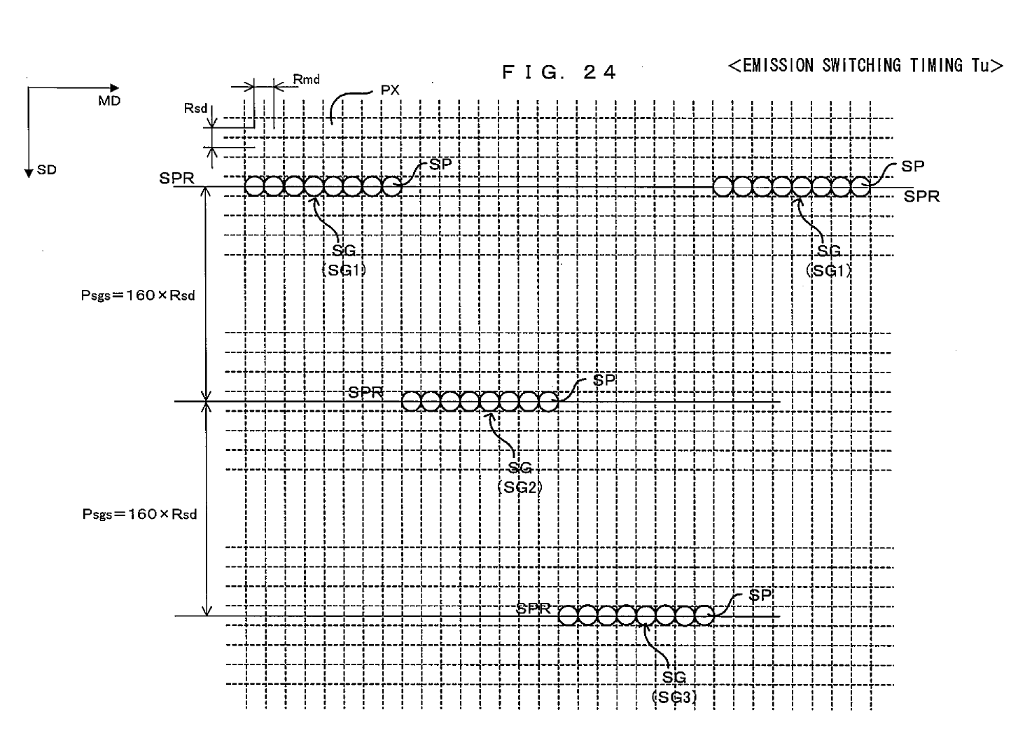

FIG. 24 is a diagram showing spot groups formed on the photosensitive drum surface at an emission switching timing Tu in a fourth embodiment. Each spot group SG is made up of one spot row SPR. In this fourth embodiment as well, the pitch Psgs in the sub scanning direction SD between the spots SP formed by the lenses LS arranged at positions different in the sub scanning direction SD is set to be an integral multiple of the pixel pitch Rsd in the sub scanning direction SD. For example, the pitch in the sub scanning direction SD between the spots SP of the spot rows SPR of the spot groups SG1 and the spots SP of the spot rows SPR of the spot groups SG2 is 160×Rsd. In this way, the emission switching timing control of the light emitting elements 2951 is simplified also in the fourth embodiment.

Although the light emitting element group column 295C is made up of three light emitting element groups 295 in the above embodiments, the number of the light emitting element groups 295 constituting the light emitting element group column 295C is not limited to this and may be two or greater.

In the above embodiments, the light emitting element groups 295 formed by grouping eight light emitting elements 2951 are discretely arranged in the longitudinal direction LGD. However, the arrangement mode of the light emitting elements 2951 is not limited to this and the light emitting elements 2951 may be arranged as follows.

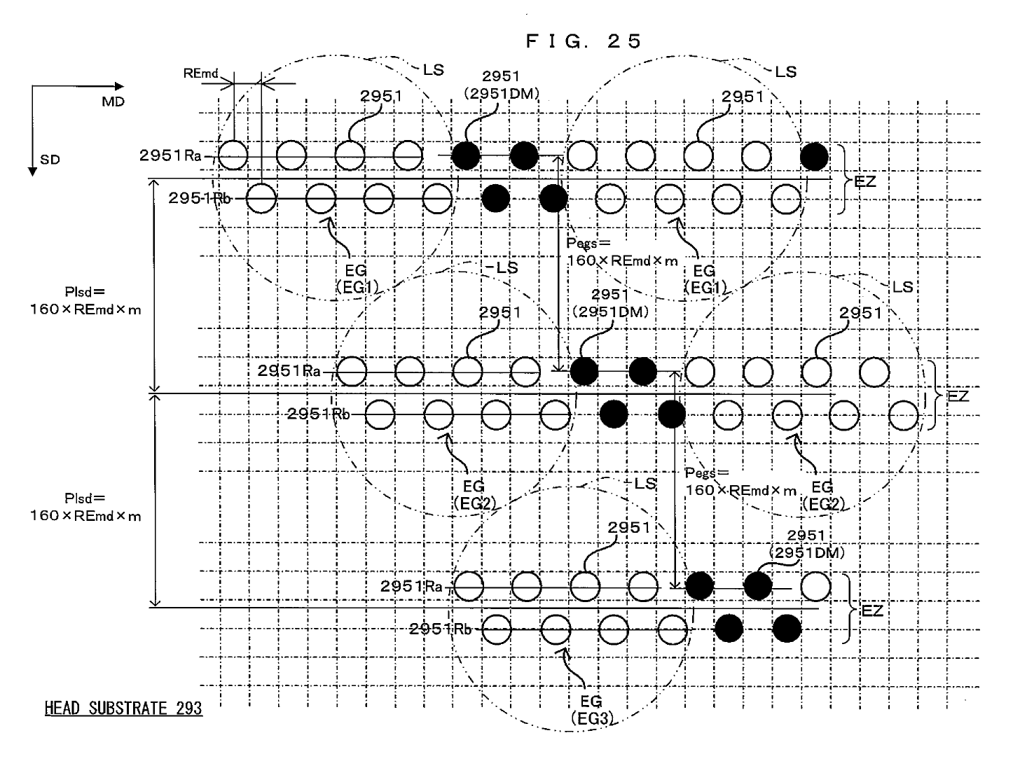

FIG. 25 is a plan view showing another arrangement mode of light emitting elements and corresponds to a plan view of the under surface of the head substrate 293 seen from the top surface side. The length of one side of a square enclosed by dashed-dotted line in FIG. 25 corresponds to a pitch REmd of the light emitting elements 2951 in the main scanning direction MD. In FIG. 25, the lenses LS are shown by chain double-dashed line. This is to show a positional relationship of the lenses LS and the light emitting elements 2951, but not to show the arrangement of the lenses LS on the under surface of the head substrate. In FIG. 25, a light emitting element zone EZ is formed by arranging a plurality of light emitting elements 2951 at positions different in the main scanning direction MD. In each light emitting element zone EZ, the plurality of light emitting elements 2951 are arranged at main-scanning pixel pitches REmd in the main scanning direction MD. Dummy light emitting elements 2951DM represented by black circles are not driven to emit lights, and lights from the light emitting elements 2951 represented by white circles are imaged by the lenses LS facing the light emitting elements 2951. In other words, each group EG made up of eight light emitting elements 2951 represented by white circles functions as the above light emitting element group 295 to form a spot group SG.

The lenses LS are arranged at sub-scanning lens pitches Plsd in the sub scanning direction SD. This sub-scanning lens pitch Plsd satisfies the following formula:

Plsd=160×REmd×m (1)

where m represents the absolute value of the optical magnification of the lenses LS and m=0.5 in FIG. 25.

When the main-scanning pixel pitch Rmd and the sub-scanning pixel pitch Rsd are equal, the following formula holds:

Rsd=REmd×m.

Accordingly,

Plsd=160×Rsd.

Further, since the sub-scanning lens pitch Plsd is equal to the sub-scanning spot group pitch Psgs, the following formula is finally obtained:

Psgs=160×Rsd.

In other words, the sub-scanning spot group pitch Psgs can be set to be an integral multiple of the sub-scanning pixel pitch Rsd by constructing the line head 29 to satisfy the formula (1).

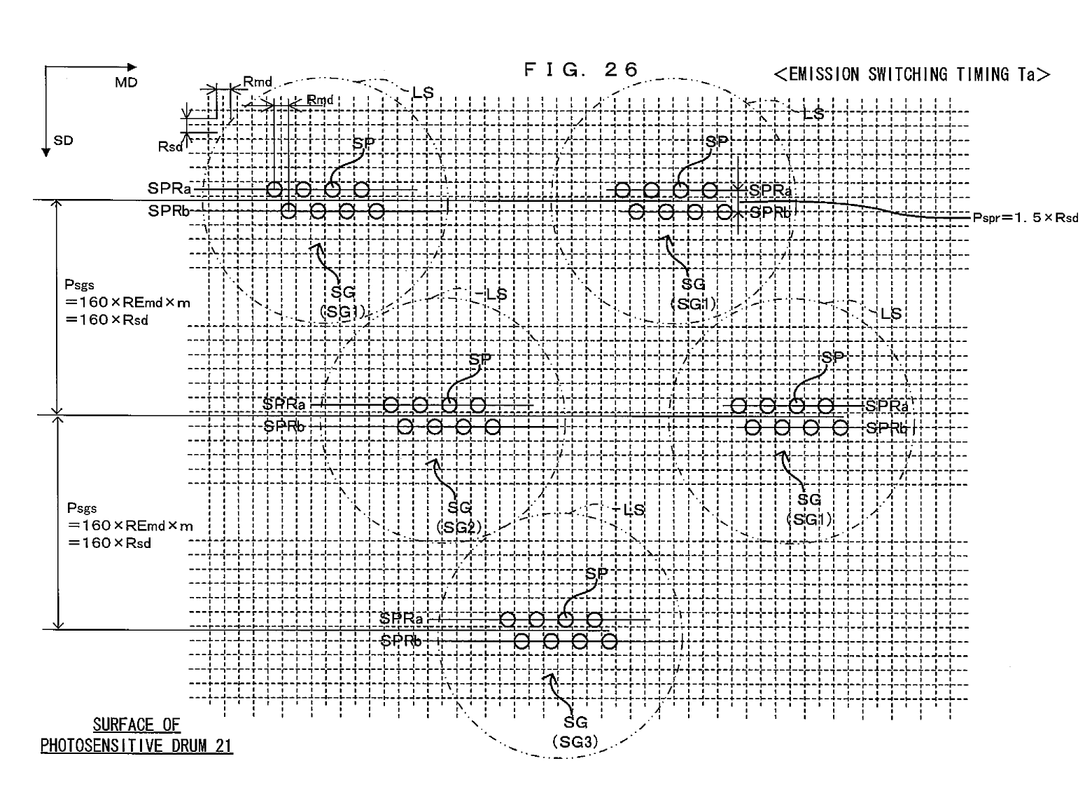

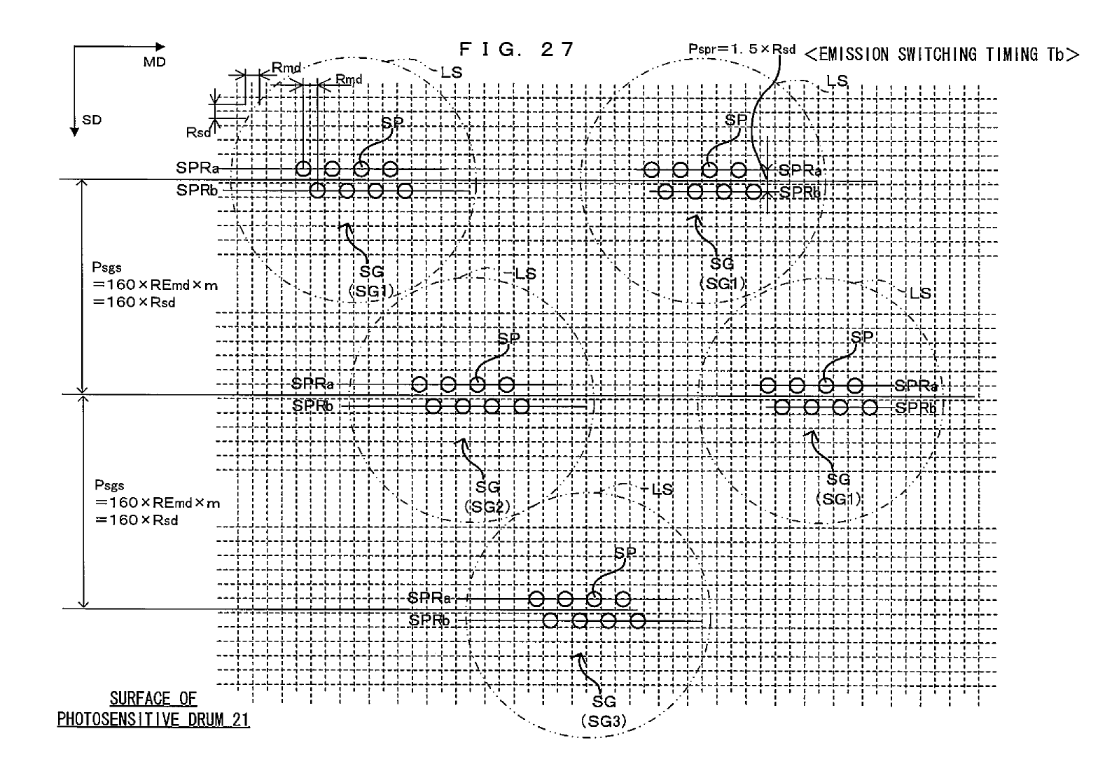

FIG. 26 is a diagram showing spot groups formed on the photosensitive drum surface at an emission switching timing Ta by the line head of FIG. 25, and FIG. 27 is a diagram showing spot groups formed on the photosensitive drum surface at an emission switching timing Tb by the line head of FIG. 25. As described above, the sub-scanning spot group pitch Psgs is set to be an integral multiple of the sub-scanning pixel pitch Rsd. Accordingly, a pitch between the spot rows SPR located at the same in-group sub-scanning positions is an integral multiple of the sub-scanning pixel pitch Rsd. For example, the pitch between the spot rows SPRa of the spot groups SG1 and the spot rows SPRa of the spot groups SG2 is an integral multiple of the sub-scanning pixel pitch Rsd (FIG. 26). Thus, these spot rows can be formed on the respective pixels PX at the same timing. Therefore, the simplification of the emission switching timing control of the light emitting elements 2951 can be realized.

In other words, the pitch Psgs in the sub scanning direction SD between the spots SP formed by the lenses LS located at positions different in the sub scanning direction SD is set to be an integral multiple of the pixel pitch Rsd in the sub scanning direction SD, whereby the emission switching timing control of the light emitting elements 2951 is simplified.

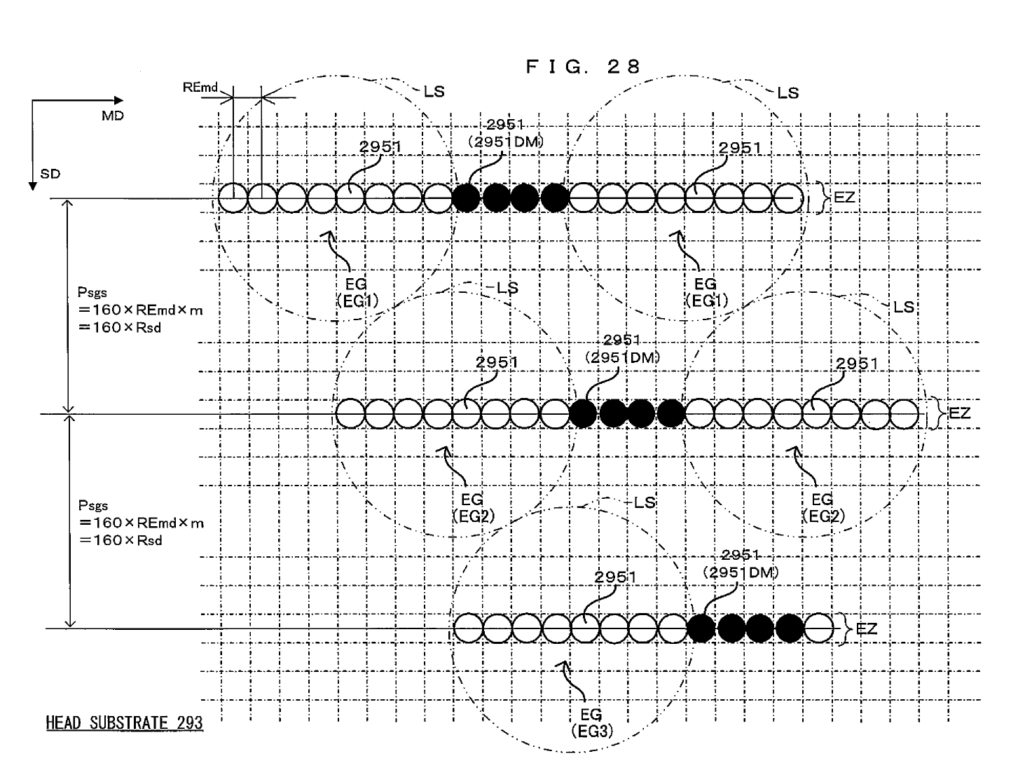

FIG. 28 is a plan view showing still another arrangement mode of light emitting elements and corresponds to a plan view of the under surface of the head substrate 293 seen from the top surface side. The length of one side of a square enclosed by dashed-dotted line in FIG. 28 corresponds to a pitch REmd of the light emitting elements 2951 in the main scanning direction MD. In FIG. 28, the lenses LS are shown by chain double-dashed line. This is to show a positional relationship of the lenses LS and the light emitting elements 2951, but not to show the arrangement of the lenses LS on the under surface of the head substrate. In FIG. 28, a light emitting element zone EZ is formed by linearly arranging a plurality of light emitting elements 2951 at the main-scanning pixel pitches REmd in the main scanning direction MD. Dummy light emitting elements 2951DM represented by black circles are not driven to emit lights, and the light emitting elements 2951 represented by white circles are driven to emit lights to be imaged by the facing lenses LS. In other words, each group EG made up of eight light emitting elements 2951 represented by white circles functions as the above light emitting element group 295 to form a spot group SG.

The lenses LS are arranged at the sub-scanning lens pitches Plsd in the sub scanning direction SD, and the sub-scanning lens pitch Plsd satisfies the following formula:

Plsd=160×REmd×m (1)

In other words, in the line head 29 shown in FIG. 28 as well, the sub-scanning spot group pitch Psgs is set to be an integral multiple of the sub-scanning pixel pitch Rsd and the emission switching timing control of the light emitting elements 2951 is simplified.

Although both the main-scanning resolution and the sub-scanning resolution are 600 dpi in the above embodiments, the respective resolutions are not limited to 600 dpi. Particularly, concerning the sub-scanning resolution, a resolution of 600 dpi or higher can be relatively easily realized by segmenting the emission times of the light emitting elements 2951 through a pulse width modulation control. Accordingly, the sub-scanning resolution may be increased, for example, to 2400 dpi while setting the main-scanning resolution to 600 dpi. At this time, the sub-scanning pixel pitch Rsd is one fourth of the main-scanning pixel pitch Rmd since the sub-scanning resolution is four times as high as the main-scanning resolution.

Although the sub-scanning spot group pitch Psgs is set to the 160-fold of the sub-scanning pixel pitch Rsd in the above embodiments, the ratio of the sub-scanning spot group pitch Psgs to the sub-scanning pixel pitch Rsd is not limited to this and the emission switching timing control of the light emitting elements 2951 can be simplified when the sub-scanning spot group pitch Psgs is an integral multiple of the sub-scanning pixel pitch Rsd.

An embodiment of an exposure head according to the invention comprises an imaging optical system and a light emitting element which emits a light to be imaged by the imaging optical system, wherein a spot is formed on a surface-to-be-exposed, and a pitch between the imaging optical systems in a moving direction of the surface-to-be-exposed is an integral multiple of a value obtained by multiplying a pitch between the light emitting elements in a direction orthogonal to or substantially orthogonal to the moving direction of the surface-to-be-exposed by an absolute value of an optical magnification of the imaging optical system.

In the embodiment (exposure head) thus constructed, the pitch between the imaging optical systems in the moving direction of the surface-to-be-exposed is an integral multiple of the value obtained by multiplying the pitch between the light emitting elements in the direction orthogonal to or substantially orthogonal to the moving direction of the surface-to-be-exposed by the absolute value of the optical magnification of the imaging optical system. Accordingly, a pitch in the moving direction of the surface-to-be-exposed between spots formed by different imaging optical systems is an integral multiple of a pixel pitch in the moving direction of the surface-to-be-exposed. Therefore, the simplification of the emission switching timing control of the light emitting element can be realized.

An embodiment of an image forming apparatus according to the invention comprises a latent image carrier and an exposure head which includes an imaging optical system and a light emitting element which emits a light to be imaged by the imaging optical system and is adapted to form a spot on the latent image carrier, wherein a pitch in a moving direction of the latent image carrier between spots formed by different imaging optical systems is an integral multiple of a pixel pitch in the moving direction of the latent image carrier.

Further, an embodiment of an image forming method according to the invention comprises the steps of: moving a latent image carrier in a moving direction; and forming a spot on the latent image carrier with a light imaged by an imaging optical system of an exposure head, wherein a pitch in the moving direction of the latent image carrier between spots formed by the different imaging optical systems is an integral multiple of a pixel pitch in the moving direction of the latent image carrier.

In the embodiment (image forming apparatus, image forming method) thus constructed, the pitch in the moving direction of the latent image carrier between spots formed by different imaging optical systems is an integral multiple of the pixel pitch in the moving direction of the latent image carrier. Therefore, the simplification of the emission switching timing control of the light emitting elements can be realized.

A pitch in the moving direction of the latent image carrier between spots formed at positions different in the moving direction of the latent image carrier by the imaging optical system may be an integral multiple of the pixel pitch in the moving direction of the latent image carrier. By such a construction, the emission switching timing control of the light emitting elements can be further simplified.

A pitch between the different imaging optical systems in the moving direction of the latent image carrier may be an integral multiple of the pixel pitch in the moving direction of the latent image carrier. By such a construction, the pitch in the moving direction of the latent image carrier between spots formed by the different imaging optical systems can be easily set to be an integral multiple of the pixel pitch in the moving direction of the latent image carrier.

An embodiment of the image forming apparatus may include a head controller and a main controller. The head controller controls light emission of the light emitting element based on video data to control spot formation on the latent image carrier and outputs a line synchronizing request signal. The main controller generates the video data and outputs, to the head controller, the video data of one line in a direction orthogonal to or substantially orthogonal to the moving direction of the latent image carrier upon receiving the line synchronizing request signal. In other words, there are cases where the video data need to be, for example, rearranged in conformity with the construction of the exposure head to drive the light emitting elements for light emissions in conformity with a two-dimensional image desired to be formed. However, in this construction, the main controller may output the video data of one line every time receiving the line synchronizing request signal without considering the rearrangement or the like of the video data in conformity with the exposure head. Therefore, a control operation by the main controller can be simplified.

At this time, the controls of the respective parts of the apparatus can be further simplified by constructing the head controller to cyclically output the line synchronizing request signal.

A driving circuit for driving the light emitting element may be provided, and the head controller may control a timing at which the driving circuit drives the light emitting element to control the spot formation. By separating the head controller and the driving circuit in this way, the driving circuit can be arranged near the light emitting element. As a result, the influence of noise and the like produced on the way from the driving circuit to the light emitting element on the other construction can be suppressed.

A control operation of the head controller can be simplified by constructing the head controller to calculate timings for driving the light emitting element in accordance with the line synchronizing request signal.

Further, a driving circuit with a good switching characteristic can be realized by constructing the driving circuit with a TFT.

A photosensitive drum can be used as the latent image carrier. In other words, the light emission of the light emitting element needs to be controlled in conformity with the rotation of the photosensitive drum in an image formation using the photosensitive drum. Accordingly, the application of the invention is preferable since an emission switching timing control of the light emitting element can be simplified.

The exposure head may include a light shielding member which is provided with a light guide hole between the light emitting element and the imaging optical system. By such a construction, crosstalk between the different imaging optical systems can be suppressed and high-quality images can be formed

The light emitting elements may be organic EL devices. Such organic EL devices have high positional accuracy since being manufactured in a semiconductor process. Therefore, high-quality images can be formed

By using bottom emission-type organic EL devices, production cost can be suppressed and high-quality images can be relatively inexpensively formed.

An embodiment of a line head (exposure head) according to another aspect of the invention comprises a substrate and an array. The substrate includes a plurality of light emitting elements grouped into light emitting element groups. The array includes an imaging optical system for each light emitting element group. The imaging optical system forms spot latent images on an image plane by imaging light beams emitted from the light emitting elements of the light emitting element groups as spots. The image plane moves in a second direction orthogonal to or substantially orthogonal to a first direction, and the light emitting elements are driven at timings in conformity with a movement of the image plane, so that the spot latent images are formed on pixels of the image plane. A plurality of light emitting element group columns each including a plurality of light emitting element groups displaced from each other in a direction corresponding to the second direction are arranged in the first direction on the substrate. The respective light emitting element groups of the light emitting element group column form spot groups at positions different in the second direction. The spot group is a set of a plurality of spots formed by the simultaneous light emissions of all the light emitting elements of the light emitting element group. A pitch between the spot groups in the second direction is an integral multiple of a pixel pitch in the second direction.

Further, an embodiment of an image forming apparatus according to another aspect of the invention comprises a latent image carrier and a line head. A surface of the latent image carrier moves in a second direction orthogonal to or substantially orthogonal to a first direction. The line head includes a substrate which is provided with a plurality of light emitting elements grouped into light emitting element groups and an array, in which imaging optical systems for forming spot latent images on the surface of the latent image carrier by imaging light beams emitted from the light emitting elements of the light emitting element groups as spots are provided in a one-to-one correspondence with the light emitting element groups. The line head is adapted to drive the light emitting elements for light emissions at timings in conformity with a movement of the latent image carrier surface to form spot latent images on pixels of the latent image carrier surface. A plurality of light emitting element group columns each including a plurality of light emitting element groups displaced from each other in a direction corresponding to the second direction are arranged in the first direction on the substrate. The respective light emitting element groups of the light emitting element group column form spot groups at positions different in the second direction. The spot group is a set of a plurality of spots formed by the simultaneous light emissions of all the light emitting elements of the light emitting element group. A pitch between the spot groups in the second direction is an integral multiple of a pixel pitch in the second direction.

In the embodiment (line head, image forming apparatus) thus constructed, the pitch between the spot groups in the second direction is an integral multiple of the pixel pitch in the second direction. Accordingly, a common emission switching timing control can be applied to the respective light emitting element groups, whereby the simplification of the emission switching timing control can be realized.

Further, the line head may be constructed such that a pitch between spots formed at position different in the second direction in the spot group is an integral multiple of the pixel pitch in the second direction. Particularly, when the line head includes a plurality of spot rows, each of which includes a plurality of spots aligned in the first direction and which are arranged in the second direction in the spot group, the line head may be constructed such that a pitch between the spot rows in the second direction is an integral multiple of the pixel pitch in the second direction. The respective spots may be formed at the same timing in such a line head. This is because the emission switching timing control of the respective light emitting element groups can be further simplified since the respective spots are formed at the same timing in the thus constructed line head.

Further, the line head may be constructed such that a plurality of spot rows each including a plurality of spots aligned in the first direction are arranged in the second direction in the spot group, a pitch between the spot rows in the second direction is a non-integral multiple of the pixel pitch in the second direction, and the respective spot rows located at the same positions in the second direction in the spot group are formed at the same timings. By such a construction, a common emission switching timing control can be applied to the respective light emitting element groups even if the pitch between the spot rows in the second direction is not an integral multiple of the pixel pitch in the second direction, wherefore the emission switching timing control can be simplified.

Further, the line head may be constructed such that a pitch between the light emitting element groups in a direction corresponding to the second direction and a pitch between the imaging optical systems in the direction corresponding to the second direction are equal and an integral multiple of the pixel pitch in the second direction. By constructing the line head in this way, a pitch between the spot groups in the second direction can be easily set to be an integral multiple of the pixel pitch in the second direction.

At this time, the line head may be constructed such that the light emitting element groups are symmetrical with respect to the optical axes of the corresponding imaging optical systems. By such a construction, the light beams of the light emitting elements can be imaged by a good optical characteristic with relatively small aberrations, wherefore high-quality spots can be formed.

Although the invention has been described with reference to specific embodiments, this description is not meant to be construed in a limiting sense. Various modifications of the disclosed embodiment, as well as other embodiments of the invention, will become apparent to persons skilled in the art upon reference to the description of the invention. It is therefore contemplated that the appended claims will cover any such modifications or embodiments as fall within the true scope of the invention.

What is claimed is:

1. An image forming apparatus, comprising:
a latent image carrier that moves in a moving direction; and
an exposure head that includes a light emitting element which emits a light and an imaging optical system which images the light emitted from the light emitting element, and is adapted to form a spot on the latent image carrier,
wherein a pitch in the moving direction of the latent image carrier between the spots formed by the different imaging optical systems is an integral multiple of a pixel pitch in the moving direction of the latent image carrier.

2. The image forming apparatus according to claim 1, wherein a pitch in the moving direction of the latent image carrier between spots formed at positions different in the moving direction of the latent image carrier by the imaging optical system is an integral multiple of the pixel pitch in the moving direction of the latent image carrier.

3. The image forming apparatus according to claim 1, wherein a pitch between the different imaging optical systems in the moving direction of the latent image carrier is an integral multiple of the pixel pitch in the moving direction of the latent image carrier.

4. The image forming apparatus according to claim 1, comprising:
a head controller that controls light emission of the light emitting element based on video data to control spot formation on the latent image carrier and outputs a line synchronizing request signal; and
a main controller that generates the video data and outputs, to the head controller, the video data of one line in a direction orthogonal to or substantially orthogonal to the moving direction of the latent image carrier upon receiving the line synchronizing request signal.

5. The image forming apparatus according to claim 4, wherein the head controller cyclically outputs the line synchronizing request signal.

6. The image forming apparatus according to claim 4, comprising a driving circuit that drives the light emitting element, wherein the head controller controls a timing at which the driving circuit drives the light emitting element to control the spot formation.

7. The image forming apparatus according to claim 6, wherein the head controller calculates the timing for driving the light emitting element in accordance with the line synchronizing request signal.

8. The image forming apparatus according to claim 6, wherein the driving circuit is constructed by a TFT.

9. The image forming apparatus according to claim 1, wherein the latent image carrier is a photosensitive drum.

10. The image forming apparatus according to claim 1, wherein the exposure head includes a light shielding member which is provided with a light guide hole between the light emitting element and the imaging optical system.

11. The image forming apparatus according to claim 10, wherein the light emitting element is an organic EL device.

12. The image forming apparatus according to claim 11, wherein the organic EL device is of a bottom emission type.

13. An exposure head, comprising:
a light emitting element which emits a light; and
an imaging optical system which images the light emitted from the light emitting element, wherein
a spot is formed on a surface-to-be-exposed which moves in a moving direction, and
a pitch between the imaging optical systems in the moving direction of the surface-to-be-exposed is an integral multiple of a value obtained by multiplying a pitch between the light emitting elements in a direction orthogonal to or substantially orthogonal to the moving direction of the surface-to-be-exposed by an absolute value of an optical magnification of the imaging optical system.

14. The exposure head according to claim 13, comprising a light shielding member which is provided with a light guide hole between the light emitting element and the imaging optical system.

15. An image forming method, comprising:
moving a latent image carrier in a moving direction; and
forming a spot on the latent image carrier with a light imaged by an imaging optical system of an exposure head, wherein
a pitch in the moving direction of the latent image carrier between spots formed by the different imaging optical systems is an integral multiple of a pixel pitch in the moving direction of the latent image carrier.
